(19) United States
(12) Patent Application Publication
(10) Pub. No.: US 2022/0210308 A1
(43) Pub. Date: Jun. 30, 2022

(54) IMAGE PROCESSING METHOD AND ELECTRONIC APPARATUS

(71) Applicant: HUAWEI TECHNOLOGIES CO., LTD., Shenzhen (CN)

(72) Inventors: Wei ZHOU, Hangzhou (CN); Chengtao ZHOU, Shenzhen (CN); Yining HUANG, Hangzhou (CN)

(73) Assignee: HUAWEI TECHNOLOGIES CO., LTD., Shenzhen (CN)

(21) Appl. No.: 17/698,161

(22) Filed: Mar. 18, 2022

Related U.S. Application Data
(63) Continuation of application No. PCT/CN2020/110734, filed on Aug. 24, 2020.

(30) Foreign Application Priority Data
Sep. 19, 2019 (CN) 201910887457.1

(51) Int. Cl. H04N 5/235; G06T 5/00; H04N 5/243

(52) U.S. Cl. CPC H04N 5/2351; G06T 5/002; G06T 2207/10016; H04N 5/243; G06T 2207/20084; H04N 5/2355

(57) ABSTRACT

Embodiments of this application disclose an image processing method and an electronic apparatus, to process a video image based on photographing environment brightness. The image processing method includes: detecting photographing environment brightness during video photographing; and when the photographing environment brightness is less than a preset threshold, processing a video image by using a neural network; or when the photographing environment brightness is greater than or equal to a preset threshold, processing a video image by using a preset denoising method, where the preset denoising method does not include a neural network architecture. A neural network in the artificial intelligence (artificial intelligence, AI) field requires a large quantity of computing units. This causes power consumption. According to the foregoing image processing method, a video image processing effect can be improved while power consumption of a terminal is ensured.

### CROSS-REFERENCE TO RELATED APPLICATIONS

This application is a continuation of International Application No PCT/CN2020/110734, filed on Aug. 24, 2020, which claims priority to Chinese Patent Application No. 201910887457.1, filed on Sep. 19, 2019. The disclosures of the aforementioned applications are hereby incorporated by reference in their entireties.

### TECHNICAL FIELD

Embodiments of this application relate to the field of computer technologies, and in particular, to an image processing method and an electronic apparatus.

### BACKGROUND

As propagation of short videos is extremely popular, customers have explosively increasing demands for video photographing, and want to photograph clear and high-quality videos at anywhere and anytime. However, photographing a video by using a mobile phone is often limited by brightness of an ambient light source. In a low illuminance (illuminance) photographing scenario, for example, environment brightness is less than 30 lux (lux), if there is no other auxiliary device, a photographed image is dark because ambient light is excessively dark and an amount of light entering a camera is small. Particularly, when the environment brightness is less than 0.1 lux, a photographed image has extremely poor quality, and the following problems occur: noise is high, and details are unrecognizable.

To resolve the problems, some manufacturers add a camera flash to a rear-facing camera of a mobile phone to improve a photographing effect in a low light environment. However, during photographing, a distance for which the flash can improve brightness is limited (a distance of up to two meters can be covered), and brightness cannot be improved for a distant object. In addition, some manufacturers use a large aperture and a photographing module with a large pixel to improve image brightness. However, this photographing module is expensive in price in one aspect, and has a relatively large thickness in another aspect, and consequently user experience is not ideal.

### SUMMARY

Embodiments of this application provide an image processing method and an electronic apparatus, to improve brightness during video photographing and mitigate a problem that a video photographed in a case of low photographing environment brightness has poor quality.

To achieve the foregoing objective, this application provides the following technical solutions:

According to a first aspect, an image processing method is provided. The method may be performed by a terminal, or may be performed by a chip in the terminal. The chip may be a processor, such as a system chip or an image signal processor (Image Signal Processor, ISP). The method includes:

detecting photographing environment brightness during video photographing; and when the photographing environment brightness is less than a preset threshold, processing, by using at least a first neural network, a first video image photographed in a case of the photographing environment brightness, to obtain a first target video image, where the first neural network is used to reduce noise of the first video image.

It should be understood that the first neural network includes but is not limited to a convolutional neural network. A neural network (for example, a convolutional neural network) can improve a video image processing effect through deep learning. Particularly, for a video image with high-frequency noise, the image processing method provided in this application can be used to optimize the video image to obtain clearer detail information of the video image.

With reference to the technical solution provided in the first aspect, in a possible implementation, the method further includes: when the photographing environment brightness is greater than or equal to the preset threshold, performing, by using a first preset denoising algorithm, denoising processing on a second video image photographed in the case of the photographing environment brightness, to obtain a second target video image, where the first preset denoising algorithm does not include a neural network.

It should be understood that although the neural network can improve a video image processing effect through deep learning, a large quantity of computing units are required. This causes extra power consumption. According to the video image processing method provided in this application, a corresponding method is selected based on the photographing environment brightness to process a video image, so that power consumption of the terminal can be reduced while a video image processing effect is improved.

With reference to the technical solution provided in the first aspect or any possible implementation of the first aspect, in a possible implementation, a photographing frame rate corresponding to the first video image is less than a photographing frame rate corresponding to the second video image.

With reference to the technical solution provided in the first aspect or any possible implementation of the first aspect, in a possible implementation, a value range of the photographing frame rate corresponding to the first video image includes [24, 30] frames per second (frame per second, fps).

It should be understood that, as the photographing environment brightness decreases, perception of human eyes for a photographing frame rate and a display frame rate of a video image may be reduced. However, because a lowest display frame rate at which the human eyes can perceive a coherent picture is 24 fps, the photographing frame rate corresponding to the first video image may be limited to a proper range that can be perceived by the human eyes, to reduce power consumption of the terminal.

It may be understood that in a specific implementation process, optionally, the value range of the photographing frame rate corresponding to the first video image may be greater than [24, 30] fps, for example, [24, 40] fps, to improve visual experience of a user.

Optionally, the value range of the photographing frame rate corresponding to the first video image may be [24, 30] fps, to improve visual experience of the user.

With reference to the technical solution provided in the first aspect or any possible implementation of the first aspect, in a possible implementation, a value range of the photographing frame rate corresponding to the second video image includes [30, 60] fps.

It should be understood that a photographing frame rate is related to exposure time. When the photographing environment brightness is greater than or equal to the preset threshold, increase of the photographing frame rate can improve visual experience of a user.

It may be understood that in a specific implementation process, optionally, the value range of the photographing frame rate corresponding to the second video image may be greater than [30, 60] fps, for example, [20, 70] fps.

With reference to the technical solution provided in the first aspect or any possible implementation of the first aspect, in a possible implementation, before the detecting photographing environment brightness, the method further includes: entering a first photographing mode, where the first photographing mode is used to indicate the terminal to detect the photographing environment brightness.

Optionally, the entering a first photographing mode specifically includes: entering the first photographing mode when detecting a first operation that a user indicates to enter the first photographing mode. Herein, the first operation may be a gesture operation (for example, sliding leftwards or sliding upwards in a photographing interface); or the first operation may be a speech instruction that is input by the user to indicate to enter the first photographing mode (for example, the user inputs “enable a night recording mode” or “enable a night photographing mode”); or the first operation may be a tapping operation (for example, the user double-taps a control used to indicate to enable the first photographing mode); or the first operation may be a knuckle operation (for example, the user draws a Z-shaped image by using a knuckle); or the first operation may be an operation that the user sets a range in which a photographing parameter meets a condition for enabling the first photographing mode (for example, the user sets photosensibility, that is, an ISO value, to 128000). The first operation may be preset before delivery of the terminal, or may be set during subsequent system upgrade.

With reference to the technical solution provided in the first aspect or any possible implementation of the first aspect, in a possible implementation, the processing, by using at least a first neural network, a video image photographed in a case of the photographing environment brightness specifically includes:

processing, by using the first neural network and a second neural network, the video image photographed in the case of the photographing environment brightness, where the second neural network is used to optimize a dynamic range of the first video image.

Optionally, that the second neural network is used to optimize a dynamic range of the first video image may include: The second neural network is used to make a histogram of the first video image uniform.

With reference to the technical solution provided in the first aspect or any possible implementation of the first aspect, in a possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing the i^{th} frame of video image by using the first neural network and/or a second neural network, where i is greater than 1.

It should be understood that according to the image processing method provided in this application, only a video image frame that is in the photographed video image and whose photographing environment brightness is less than the preset threshold is processed by using a neural network, to further effectively reduce power consumption of the terminal.

In another possible implementation, when the photographing environment brightness is less than the preset threshold, the processing, by using at least a first neural network, a first video image photographed in a case of the photographing environment brightness specifically includes:

when determining that average photographing environment brightness of an i^{th} frame of video image to a j^{th} frame of video image in the photographed video image is less than the preset threshold, processing the i^{th} frame of video image to the i^{th} frame of video image by using the first neural network and/or a second neural network, where 1≤i≤j≤N.

It should be understood that video image sampling difficulty is reduced based on average photographing environment brightness of a plurality of consecutive frames of video images or average photographing environment brightness of a plurality of consecutive frames of video images spaced apart, and this is easier to implement.

In still another possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing a k^{th} frame of video image to a j^{th} frame of video image by using the first neural network and/or a second neural network, where 1≤k≤i≤j≤N.

It should be understood that the photographing environment brightness may change gradually. Therefore, based on a video image frame that is detected for the first time and whose photographing environment brightness is less than the preset threshold in the photographed video image, several consecutive frames after the video image frame are processed by using a neural network, so that a video image processing effect can be improved, video image continuity can be ensured, and implementation difficulty can be reduced.

In yet another possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing the i^{th} frame of video image to an N^{th} frame of video image by using the first neural network and/or a second neural network, where 1≤i≤N, and N is a total quantity of frames in the photographed video image.

In addition, in the foregoing possible implementations, i, k, and j each should be less than or equal to the total quantity N of frames in the photographed video image.

It should be understood that based on a video image frame that is detected for the first time and whose photographing environment brightness is less than the preset threshold in the photographed video image, each video image frame starting from the video image frame in the video image is processed by using a neural network, so that a video image processing effect can be improved and video image continuity can be ensured, but power consumption is relatively large.

With reference to the technical solution provided in the first aspect or any possible implementation of the first aspect, in a possible implementation, the detecting photographing environment brightness of a video image specifically includes:

determining the photographing environment brightness of the video image based on a photographing parameter for photographing a video, or sensing information of an ambient light sensor of the terminal photographing the video, or average image brightness of the video image.

The photographing parameter includes one or more of photosensibility, exposure time, and an aperture size.

It should be understood that in a specific implementation process, optionally, the sensing information may be a photographing environment brightness measurement result obtained by the ambient light sensor through measurement, for example, 0.1 lux. Optionally, the sensing information may be a photographing environment brightness measurement result processed through calculation, for example, quantization information of photographing environment brightness obtained by the ambient light sensor through measurement, or brightness level information obtained based on a predefined mapping relationship and a photographing environment brightness that is obtained by the ambient light sensor through measurement. Optionally, the sensing information may be an indication signal, for example, a result of comparing a photographing environment brightness obtained by the ambient light sensor through measurement with a threshold, where the indication signal may be a high level or a low level, which has an indication bit 0 or 1. For example, the high level is used to indicate that photographing environment brightness currently obtained through measurement is less than the threshold, and the low level is used to indicate that the photographing environment brightness currently obtained through measurement is greater than the threshold.

It should be further understood that the processor may obtain, by using an interface circuit, the sensing information of the ambient light sensor of the terminal photographing the video image, and determine photographing environment brightness of the terminal. Specifically, the sensing information may be obtained by using the ambient light sensor by an interface circuit connected to the ambient light sensor, or may be obtained, by using a memory that stores a measurement result of the ambient light sensor, by an interface circuit connected to the memory.

The photosensibility may be an ISO value. Specifically, the photographing parameter is set by a user, or is set by the terminal based on video image information obtained by a camera, or is set by the terminal based on the sensing information obtained by the ambient light sensor through measurement. The photographing environment brightness is inversely proportional to the photosensibility (or the exposure time), that is, higher photosensibility indicates lower photographing environment brightness of the video image.

It should be understood that in this application, the first neural network and the second neural network each may be a convolutional neural network. Optionally, in a specific implementation process, processing of the convolutional neural network may be accelerated by using an accelerator, to implement real-time processing. The accelerator may be a neural-network processing unit (neural-network processing unit, NPU).

With reference to the technical solution provided in the first aspect or any possible implementation of the first aspect, in a possible implementation, the preset threshold is less than or equal to 5 lux. For example, the preset threshold is 0.2 lux, or the preset threshold is 1 lux.

With reference to the technical solution provided in the first aspect or any possible implementation of the first aspect, in a possible implementation, the method further includes:

displaying a video image photographed in case of current photographing environment brightness;

displaying the first target video image; or

displaying the second target video image.

It should be understood that in a specific implementation process, to reduce power consumption, a video image (for example, a video image photographed by a camera or a video image obtained after processing is performed by using a preset denoising algorithm) not processed by a neural network may be previewed and displayed in a photographing interface, and a video image processed by using the neural network is stored for play by a user. A photographed video image may be alternatively processed by using a neural network, and a video image processed by using the neural network is previewed and displayed in a photographed interface, to improve visual experience of a user.

According to a second aspect, an image processing method is provided. The method may be performed by a terminal, or may be performed by a chip in the terminal. The chip may be a processor, such as a system chip or an image signal processor (Image Signal Processor, ISP). The method includes:

detecting photographing environment brightness during video photographing; and when the photographing environment brightness is less than a preset threshold, processing, by using at least a first neural network, a first video image photographed in a case of the photographing environment brightness, to obtain a first target video image, where the first neural network is used to optimize a dynamic range of the first video image.

With reference to the technical solution provided in the second aspect, in a possible implementation, that the first neural network is used to optimize a dynamic range of the first video image may include: The second neural network is used to make a histogram of the first video image uniform.

With reference to the technical solution provided in the second aspect, in a possible implementation, the method further includes: when the photographing environment brightness is greater than or equal to the preset threshold, performing, by using a first preset denoising algorithm, denoising processing on a second video image photographed in the case of the photographing environment brightness, to obtain a second target video image, where the first preset denoising algorithm does not include a neural network.

With reference to the technical solution provided in the second aspect or any possible implementation of the second aspect, in a possible implementation, a photographing frame rate corresponding to the first video image is less than a photographing frame rate corresponding to the second video image.

With reference to the technical solution provided in the second aspect or any possible implementation of the second aspect, in a possible implementation, a value range of the photographing frame rate corresponding to the first video image includes [24,30] frames per second (frame per second, fps).

With reference to the technical solution provided in the second aspect or any possible implementation of the second aspect, in a possible implementation, a value range of the photographing frame rate corresponding to the second video image includes [30, 60] fps.

With reference to the technical solution provided in the second aspect or any possible implementation of the second aspect, in a possible implementation, before the detecting photographing environment brightness, the method further includes: entering a first photographing mode, where the first photographing mode is used to indicate the terminal to detect the photographing environment brightness.

With reference to the technical solution provided in the second aspect or any possible implementation of the second aspect, in a possible implementation, the processing, by using at least a first neural network, a video image photographed in a case of the photographing environment brightness specifically includes:

processing, by using the first neural network and a second neural network, the video image photographed in the case of the photographing environment brightness, where the second neural network is used to reduce noise of the first video image.

With reference to the technical solution provided in the second aspect or any possible implementation of the second aspect, in a possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing the i^{th} frame of video image by using the first neural network, where i is greater than 1.

It should be understood that according to the image processing method provided in this application, only a video image frame that is in the photographed video image and whose photographing environment brightness is less than the preset threshold is processed by using a neural network, to further effectively reduce power consumption of the terminal.

In another possible implementation, when the photographing environment brightness is less than the preset threshold, the processing, by using at least a first neural network, a first video image photographed in a case of the photographing environment brightness specifically includes:

when determining that average photographing environment brightness of an i^{th} frame of video image to a j^{th} frame of video image in the photographed video image is less than the preset threshold, processing the i^{th} frame of video image to the i^{th} frame of video image by using the first neural network, where 1≤i≤j≤N.

It should be understood that video image sampling difficulty is reduced based on average photographing environment brightness of a plurality of consecutive frames of video images or average photographing environment brightness of a plurality of consecutive frames of video images spaced apart, and this is easier to implement.

In still another possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing a k^{th} frame of video image to a j^{th} frame of video image by using the first neural network, where 1≤k≤i≤j≤N.

It should be understood that the photographing environment brightness may change gradually. Therefore, based on a video image frame that is detected for the first time and whose photographing environment brightness is less than the preset threshold in the photographed video image, several consecutive frames after the video image frame are processed by using a neural network, so that a video image processing effect can be improved, video image continuity can be ensured, and implementation difficulty can be reduced.

In yet another possible implementation, when the photographing environment brightness is less than the preset threshold, the processing, by using at least a first neural network, a first video image photographed in a case of the photographing environment brightness specifically includes:

when determining that photographing environment brightness of an i^{th} frame of video image in the photographed video image is less than the preset threshold, processing the i^{th} frame of video image to an N^{th} frame of video image by using the first neural network, where 1≤i≤N, and N is a total quantity of frames in the photographed video image.

In addition, in the foregoing possible implementations, i, k, and j each should be less than or equal to the total quantity N of frames in the photographed video image.

It should be understood that based on a video image frame that is detected for the first time and whose photographing environment brightness is less than the preset threshold in the photographed video image, each video image frame starting from the video image frame in the video image is processed by using a neural network, so that a video image processing effect can be improved and video image continuity can be ensured, but power consumption is relatively large.

With reference to the technical solution provided in the second aspect or any possible implementation of the second aspect, in a possible implementation, the detecting photographing environment brightness of a video image specifically includes:

determining the photographing environment brightness of the video image based on a photographing parameter for photographing a video, or sensing information of an ambient light sensor of the terminal photographing the video, or average image brightness of the video image.

The photographing parameter includes one or more of photosensibility, exposure time, and an aperture size.

It should be understood that in a specific implementation process, optionally, the sensing information may be a photographing environment brightness measurement result obtained by the ambient light sensor through measurement, for example, 0.1 lux. Optionally, the sensing information may be a photographing environment brightness measurement result processed through calculation, for example, quantization information of photographing environment brightness obtained by the ambient light sensor through measurement, or brightness level information obtained based on a predefined mapping relationship and a photographing environment brightness that is obtained by the ambient light sensor through measurement. Optionally, the sensing information may be an indication signal, for example, a result of comparing a photographing environment brightness obtained by the ambient light sensor through measurement with a threshold, where the indication signal may be a high level or a low level, which has an indication bit 0 or 1. For example, the high level is used to indicate that photographing environment brightness currently obtained through measurement is less than the threshold, and the low level is used to indicate that the photographing environment brightness currently obtained through measurement is greater than the threshold.

It should be further understood that the processor may obtain, by using an interface circuit, the sensing information of the ambient light sensor of the terminal photographing the video image, and determine photographing environment brightness of the terminal. Specifically, the sensing information may be obtained by using the ambient light sensor by an interface circuit connected to the ambient light sensor, or may be obtained, by using a memory that stores a measurement result of the ambient light sensor, by an interface circuit connected to the memory.

The photosensibility may be an ISO value. Specifically, the photographing parameter is set by a user, or is set by the terminal based on video image information obtained by a camera, or is set by the terminal based on the sensing information obtained by the ambient light sensor through measurement. The photographing environment brightness is inversely proportional to the photosensibility (or the exposure time), that is, higher photosensibility indicates lower photographing environment brightness of the video image.

It should be understood that in this application, the first neural network and the second neural network each may be a convolutional neural network. Optionally, in a specific implementation process, processing of the convolutional neural network may be accelerated by using an accelerator, to implement real-time processing. The accelerator may be a neural-network processing unit (neural-network processing unit, NPU).

With reference to the technical solution provided in the second aspect or any possible implementation of the second aspect, in a possible implementation, the preset threshold is less than or equal to 5 lux. For example, the preset threshold is 0.2 lux, or the preset threshold is 1 lux.

With reference to the technical solution provided in the second aspect or any possible implementation of the second aspect, in a possible implementation, the method further includes:

displaying a video image photographed in a case of current photographing environment brightness;

displaying the first target video image; or

displaying the second target video image.

It should be understood that in a specific implementation process, to reduce power consumption, a video image (for example, a video image photographed by a camera or a video image obtained after processing is performed by using a preset denoising algorithm) not processed by a neural network may be previewed and displayed in a photographing interface, and a video image processed by using the neural network is stored for play by a user. A photographed video image may be alternatively processed by using a neural network, and a video image processed by using the neural network is previewed and displayed in a photographed interface, to improve visual experience of a user.

According to a third aspect, an image processing apparatus is provided, and the image processing apparatus may be configured to perform the image processing method according to the first aspect, the second aspect, or any possible implementation. The apparatus includes:

a detection unit, configured to detect photographing environment brightness during video photographing; and a processing unit, configured to: when the photographing environment brightness is less than a preset threshold, process, by using at least a first neural network, a first video image photographed in a case of the photographing environment brightness, to obtain a first target video image, where the first neural network is used to reduce noise of the first video image.

It should be understood that in a specific implementation process, optionally, the detection unit and the processing unit may be implemented by program code having a specific function. Alternatively, the detection unit and the processing unit may be implemented by a detector and a processor.

According to a fourth aspect, an embodiment of this application provides an electronic apparatus. The electronic apparatus may include a processor and a memory, and the processor is coupled to the memory. The memory may be configured to store computer program code, and the computer program code includes computer instructions. When the computer instructions are executed by the electronic apparatus, the electronic apparatus performs the image processing method according to the first aspect, the second aspect, or any possible implementation.

According to a fifth aspect, an embodiment of this application provides a computer-readable storage medium. The computer-readable storage medium may include computer software instructions. When the computer software instructions are run in an electronic apparatus, the electronic apparatus is enabled to perform the image processing method according to the first aspect, the second aspect, or any possible implementation of the first aspect.

According to a sixth aspect, an embodiment of this application provides a computer program product. When the computer program product runs on a computer, the computer is enabled to perform the image processing method according to the first aspect, the second aspect, or any possible implementation.

According to a seventh aspect, an embodiment of this application provides a chip system, and the chip system is applied to an electronic apparatus. The chip system includes an interface circuit and a processor, and the interface circuit and the processor are interconnected through a line. The interface circuit is configured to receive a signal from a memory of the electronic apparatus, and send a signal to the processor, where the signal includes computer instructions stored in the memory. When the processor executes the computer instructions, the chip system performs the image processing method according to the first aspect, the second aspect, or any possible implementation.

According to an eighth aspect, an embodiment of this application provides a graphical user interface (graphical user interface, GUI), and the graphical user interface is stored in an electronic apparatus. The electronic apparatus includes a display, a memory, and one or more processors. The one or more processors are configured to execute one or more computer programs stored in the memory. The graphical user interface includes a GUI displayed on the display, and the GUI includes a video picture. The video picture includes an i^{th} frame of video image processed in the first aspect or any possible implementation, and the video picture is transmitted by another electronic apparatus (for example, the another electronic apparatus is referred to as a second electronic apparatus) to the electronic apparatus, where the second electronic apparatus includes a display and a camera.

According to a ninth aspect, an embodiment of this application provides a terminal, including a camera and a processor.

The camera is configured to photograph a video image.

The processor is configured to: when photographing environment brightness is less than a preset threshold, process, by using at least a first neural network, a first video image photographed in a case of the photographing environment brightness, to obtain a first target video image.

With reference to the technical solution provided in the ninth aspect, in a possible implementation, a value range of a photographing frame rate corresponding to the first video image includes [24, 30] fps.

With reference to the technical solution provided in the ninth aspect or any possible implementation of the ninth aspect, in a possible implementation, the processor is further configured to: when the photographing environment brightness is greater than or equal to the preset threshold, perform, by using a first preset denoising algorithm, denoising processing on a second video image photographed in the case of the photographing environment brightness, to obtain a second target video image. The first preset denoising algorithm does not include a neural network.

With reference to the technical solution provided in the ninth aspect or any possible implementation of the ninth aspect, in a possible implementation, a value range of the photographing frame rate corresponding to the second video image includes [30, 60] fps.

With reference to the technical solution provided in the ninth aspect or any possible implementation of the ninth aspect, in a possible implementation, the processor is further configured to detect the photographing environment brightness. Specifically, for example, the processor detects the photographing environment brightness by using an interface circuit.

With reference to the technical solution provided in the ninth aspect or any possible implementation of the ninth aspect, in a possible implementation, the terminal further includes an ambient light sensor, configured to detect photographing environment brightness of the terminal.

In another possible implementation, the processor is further configured to determine, based on the video image photographed by the camera, the photographing environment brightness of the terminal.

In still another possible implementation, the processor is further configured to determine, based on a photographing parameter set by a user, the photographing environment brightness of the terminal. The photographing parameter includes one or more of photosensibility, exposure time, and an aperture size.

With reference to the technical solution provided in the ninth aspect or any possible implementation of the ninth aspect, in a possible implementation, the processor is further configured to: before detecting the photographing environment brightness, enable the terminal to enter a first photographing mode, where the first photographing mode is used to indicate the terminal to detect the photographing environment brightness.

With reference to the technical solution provided in the ninth aspect or any possible implementation of the ninth aspect, in a possible implementation, the processor is specifically configured to: when determining that photographing environment brightness of an i^{th} frame of video image in the video image is less than a threshold, process the i^{th} frame of video image by using a convolutional neural network, where i is greater than 1.

With reference to the technical solution provided in the ninth aspect or any possible implementation of the ninth aspect, in a possible implementation, the terminal further includes a touchscreen display, configured to display a video image photographed in a case of current photographing environment brightness.

In another possible implementation, the terminal further includes a touchscreen display, configured to display the first target video image.

In still another possible implementation, the terminal further includes a touchscreen display, configured to display the second target video image.

It should be understood that descriptions of technical features, technical solutions, beneficial effects, or similar statements in this application do not imply that all features and advantages can be implemented in any single embodiment. On the contrary, it may be understood that descriptions of the features or the beneficial effects mean that at least one embodiment includes a specific technical feature, technical solution, or beneficial effect. Therefore, descriptions of the technical features, the technical solutions, or the beneficial effects in this specification may not necessarily be specific to a same embodiment. Alternatively, the technical features, technical solutions, or beneficial effects described in the embodiments may be combined in any proper manner. A person skilled in the art may understand that a specific embodiment may be implemented without using one or more specific technical features, technical solutions, or beneficial effects of the embodiment. In other embodiments, additional technical features and beneficial effects may further be identified in a specific embodiment that does not reflect all the embodiments.

### BRIEF DESCRIPTION OF DRAWINGS

FIG. 1 is a schematic diagram of a hardware structure of an electronic apparatus according to an embodiment of this application;

FIG. 2 is a schematic diagram of a software structure of an electronic apparatus according to an embodiment of this application;

FIG. 3(a) and FIG. 3(b) show graphical user interfaces of a mobile phone according to an embodiment of this application;

FIG. 4(a) and FIG. 4(b) show other graphical user interfaces of a mobile phone according to an embodiment of this application;

FIG. 5(a) and FIG. 5(b) show still other graphical user interfaces of a mobile phone according to an embodiment of this application;

FIG. 6 is a schematic flowchart of an image processing method according to an embodiment of this application;

FIG. 7(a), FIG. 7(b), FIG. 7(c), and FIG. 7(d) show still other graphical user interfaces of a mobile phone according to an embodiment of this application;

FIG. 8(a), FIG. 8(b), and FIG. 8(c) are schematic diagrams of procedures of a neural network according to an embodiment of this application;

FIG. 9 shows an example design of a network architecture of a denoising unit according to an embodiment of this application;

FIG. 10 shows an example design of a network architecture of a dynamic range conversion unit according to an embodiment of this application;

FIG. 11 is a schematic flowchart of another image processing method according to an embodiment of this application;

FIG. 12(a), FIG. 12(b), FIG. 12(c), and FIG. 12(d) show still other graphical user interfaces of a mobile phone according to an embodiment of this application;

FIG. 13(a), FIG. 13(b), FIG. 13(c), and FIG. 13(d) show still other graphical user interfaces of a mobile phone according to an embodiment of this application;

FIG. 14(a) and FIG. 14(b) show still other graphical user interfaces of a mobile phone according to an embodiment of this application;

FIG. 15(a) and FIG. 15(b) show still other graphical user interfaces of a mobile phone according to an embodiment of this application;

FIG. 16(a) and FIG. 16(b) show still other graphical user interfaces of a mobile phone according to an embodiment of this application;

FIG. 17 is a schematic diagram of a structure of an image processing apparatus according to an embodiment of this application; and

FIG. 18 is a schematic diagram of a structure of another image processing apparatus according to an embodiment of this application.

### DESCRIPTION OF EMBODIMENTS

The following clearly describes the technical solutions in the embodiments of this application with reference to the accompanying drawings in the embodiments of this application.

Embodiments of this application provide an image processing solution, including an image processing method and an electronic apparatus. The processing solution may be used to process a video image based on video photographing environment brightness when a photo is photographed or a video is photographed. Specifically, in a low-illuminance photographing scenario, the video image is processed based on a neural network, to improve image brightness while increasing a signal to noise ratio (signal to noise ratio, SNR) of the image. In a non-low illuminance photographing scenario, the video image is processed by using a preset denoising algorithm, to reduce power consumption of a terminal. Herein, the neural network may include but is not limited to a convolutional neural network (convolutional neural network, CNN).

The image processing method provided in the embodiments of this application may be applied to an electronic apparatus. The electronic apparatus may be a terminal, or may be a chip inside the terminal. For example, the terminal is an electronic apparatus such as a mobile phone, a tablet computer, a wearable device, a vehicle-mounted device, an augmented reality (augmented reality, AR)/virtual reality (virtual reality, VR) device, a notebook computer, an ultra-mobile personal computer (ultra-mobile personal computer, UMPC), a netbook, or a personal digital assistant (personal digital assistant, PDA). A specific type of the electronic apparatus is not limited in embodiments of this application.

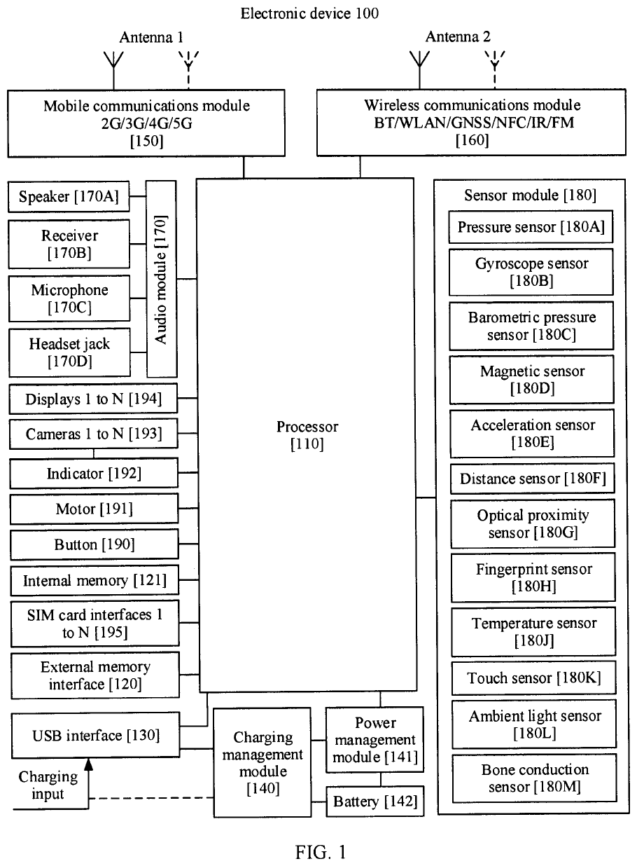

FIG. 1 is a schematic diagram of a hardware structure of an electronic apparatus according to an embodiment of this application. As shown in FIG. 1, an electronic apparatus 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic apparatus 100. In some other embodiments of this application, the electronic apparatus 100 may include more or fewer components than the components shown in the figure, some components may be combined, or some components may be split, or different component arrangements may be used. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU). Different processing units may be independent devices, or may be integrated into one or more processors.

The controller may be a neural center and a command center of the electronic apparatus 100. The controller may generate an operation control signal based on an instruction operation code and a time sequence signal, to complete control of instruction reading and instruction execution.

A memory may be further disposed in the processor 110, and is configured to store instructions and data. In some embodiments, the memory in the processor 110 is a cache. The memory may store instructions or data that has just been used or is cyclically used by the processor 110. If the processor 110 needs to use the instructions or the data again, the processor 110 may directly invoke the instructions or the data from the memory. This avoids repeated access and reduces waiting time of the processor 110. Therefore, system efficiency is improved.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) port, and/or the like.

The I2C interface is a two-way synchronous serial bus, including a serial data line (serial data line, SDA) and a serial clock line (serial clock line, SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic apparatus 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transfer an audio signal to the wireless communications module 160 through the I2S interface, to implement a function of answering a call by using a Bluetooth headset.

The PCM interface may also be configured to perform audio communication, and sample, quantize, and encode an analog signal. In some embodiments, the audio module 170 may be coupled to the wireless communications module 160 through a PCM bus interface. In some embodiments, the audio module 170 may also transfer an audio signal to the wireless communications module 160 through the PCM interface, to implement a function of answering a call by using the Bluetooth headset. Both the I2S interface and the PCM interface may be configured to perform audio communication.

The UART interface is a universal serial data bus, and is configured to perform asynchronous communication. The bus may be a two-way communications bus. The bus converts to-be-transmitted data between serial communication and parallel communication. In some embodiments, the UART interface is usually configured to connect the processor 110 to the wireless communications module 160. For example, the processor 110 communicates with a Bluetooth module in the wireless communications module 160 through the UART interface, to implement a Bluetooth function. In some embodiments, the audio module 170 may transfer an audio signal to the wireless communications module 160 through the UART interface, to implement a function of playing music by using the Bluetooth headset.

The MIPI interface may be configured to connect the processor 110 to a peripheral component such as the display 194 or the camera 193. The MIPI interface includes a camera serial interface (camera serial interface, CSI), a display serial interface (display serial interface, DSI), and the like. In some embodiments, the processor 110 communicates with the camera 193 through the CSI interface, to implement a photographing function of the electronic apparatus 100. The processor 110 communicates with the display 194 through the DSI interface, to implement a display function of the electronic apparatus 100.

The GPIO interface may be configured by using software. The GPIO interface may be configured as a control signal or a data signal. In some embodiments, the GPIO interface may be configured to connect the processor 110 to the camera 193, the display 194, the wireless communications module 160, the audio module 170, the sensor module 180, and the like. The GPIO interface may alternatively be configured as an I2C interface, an I2S interface, a UART interface, an MIPI interface, or the like.

The USB interface 130 is an interface that complies with a USB standard specification, and may be specifically a mini USB interface, a micro USB interface, a USB Type-C interface, or the like. The USB interface 130 may be configured to connect to the charger to charge the electronic apparatus 100, or may be configured to transmit data between the electronic apparatus 100 and a peripheral device, or may be configured to connect to a headset, to play audio by using the headset. The interface may be further configured to connect to another electronic apparatus such as an AR device.

It may be understood that an interface connection relationship between modules illustrated in this embodiment of this application is merely an example for description, and does not constitute a limitation on the structure of the electronic apparatus 100. In some other embodiments of this application, the electronic apparatus 100 may alternatively use an interface connection manner different from that in the foregoing embodiment, or a combination of a plurality of interface connection manners.

The charging management module 140 is configured to receive a charging input from the charger. The charger may be a wireless charger or a wired charger. In some embodiments in which wired charging is used, the charging management module 140 may receive a charging input from the wired charger through the USB interface 130. In some embodiments in which wireless charging is used, the charging management module 140 may receive a wireless charging input through a wireless charging coil of the electronic apparatus 100. When charging the battery 142, the charging management module 140 may further supply power to the electronic apparatus through the power management module 141.

The power management module 141 is configured to connect to the battery 142, the charging management module 140, and the processor 110. The power management module 141 receives an input of the battery 142 and/or the charging management module 140, and supplies power to the processor 110, the internal memory 121, an external memory, the display 194, the camera 193, the wireless communications module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic apparatus 100 may be implemented by the antenna 1, the antenna 2, the mobile communications module 150, the wireless communications module 160, the modem processor, the baseband processor, and the like.

The antenna 1 and the antenna 2 are configured to transmit and receive electromagnetic wave signals. Each antenna in the electronic apparatus 100 may be configured to cover a single communications frequency band or a plurality of communications frequency bands. Different antennas may be multiplexed, to improve antenna utilization. For example, the antenna 1 may be multiplexed as a diversity antenna in a wireless local area network. In some other embodiments, an antenna may be used in combination with a tuning switch.

The mobile communications module 150 may provide a solution for wireless communication including 2G/3G/4G/5G and the like applied to the electronic apparatus 100. The mobile communications module 150 may include at least one filter, a switch, a power amplifier, a low noise amplifier (low noise amplifier, LNA), and the like. The mobile communications module 150 may receive an electromagnetic wave through the antenna 1, perform processing such as filtering and amplification on the received electromagnetic wave, and transmit a processed electromagnetic wave to the modem processor for demodulation. The mobile communications module 150 may further amplify a signal modulated by the modem processor, and convert the signal into an electromagnetic wave for radiation through the antenna 1. In some embodiments, at least some function modules of the mobile communications module 150 may be disposed in the processor 110. In some embodiments, at least some function modules in the mobile communications module 150 may be disposed in a same device as at least some modules in the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The baseband processor processes the low-frequency baseband signal, and then transmits a processed signal to the application processor. The application processor outputs a sound signal through an audio device (which is not limited to the speaker 170A, the receiver 170B, or the like), or displays an image or a video on the display 194. In some embodiments, the modem processor may be an independent component. In some other embodiments, the modem processor may be independent of the processor 110, and is disposed in a same device as the mobile communications module 150 or another function module.

The wireless communications module 160 may provide a wireless communication solution that includes a wireless local area network (wireless local area networks, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like and that is applied to the electronic apparatus 100. The wireless communications module 160 may be one or more components integrating at least one communications processing module. The wireless communications module 160 receives an electromagnetic wave through the antenna 2, performs frequency modulation and filtering processing on the electromagnetic wave signal, and sends a processed signal to the processor 110. The wireless communications module 160 may further receive a to-be-sent signal from the processor 110, perform frequency modulation and amplification on the signal, and convert the signal into an electromagnetic wave for radiation through the antenna 2.

In some embodiments, the antenna 1 and the mobile communications module 150 of the electronic apparatus 100 are coupled, and the antenna 2 and the wireless communications module 160 are coupled, so that the electronic apparatus 100 can communicate with a network and another device by using a wireless communications technology. The wireless communications technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation system, SBAS).

The electronic apparatus 100 implements a display function by using the GPU, the display 194, the application processor, and the like. The GPU is a microprocessor for image processing, and is connected to the display 194 and the application processor. The GPU is configured to: perform mathematical and geometric calculation, and render an image. The processor 110 may include one or more GPUs that execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini-LED, a micro-LED, a micro-OLED, quantum dot light emitting diodes (quantum dot light emitting diodes, QLED), or the like. In some embodiments, the electronic apparatus 100 may include one or N displays 194, where N is a positive integer greater than 1.

The electronic apparatus 100 may implement a photographing function by using the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated by the lens, and is projected to the photosensitive element. The photosensitive element may be a charge coupled device (charge coupled device, CCD) or a complementary metal-oxide-semiconductor (complementary metal-oxide-semiconductor, CMOS) photoelectric transistor. The photosensitive element converts an optical signal into an electrical signal, and then transmits the electrical signal to the ISP for converting the electrical signal into a digital image signal. The ISP outputs the digital image signal to the DSP for processing. The DSP converts the digital image signal into a standard image signal in an RGB format, a YUV format, or the like. In some embodiments, the electronic apparatus 100 may include one or N cameras 193, where N is a positive integer greater than 1.

The digital signal processor is configured to process a digital signal, and may process another digital signal in addition to the digital image signal. For example, when the electronic apparatus 100 selects a frequency, the digital signal processor is configured to perform Fourier transform or the like on frequency energy.

The video codec is configured to: compress or decompress a digital video. The electronic apparatus 100 can support one or more video codecs. Therefore, the electronic apparatus 100 can play or record videos of a plurality of coding formats, for example, moving picture experts group (moving picture experts group, MPEG)-1, MPEG-2, MPEG-3, and MPEG-4.

The NPU is a neural-network (neural-network, NN) computing processor that rapidly processes input information by referring to a structure of a biological neural network, for example, by referring to a transfer mode between human brain neurons, and can further perform self-learning continuously. Applications such as intelligent cognition of the electronic apparatus 100 can be implemented by using the NPU, such as image recognition, facial recognition, speech recognition, and text understanding.

The external memory interface 120 may be configured to connect to an external storage card such as a micro SD card, to extend a storage capability of the electronic apparatus 100. The external memory card communicates with the processor 110 through the external memory interface 120, to implement a data storage function. For example, files such as music and videos are stored in the external memory card.

The internal memory 121 may be configured to store computer-executable program code. The executable program code includes instructions. The processor 110 runs the instructions stored in the internal memory 121, to perform various function applications of the electronic apparatus 100 and process data. The internal memory 121 may include a program storage area and a data storage area. The program storage area may store an operating system, an application required by at least one function (for example, a sound playing function or an image playing function), and the like. The data storage area may store data (such as audio data and a phone book) and the like created during use of the electronic apparatus 100. In addition, the internal memory 121 may include a high-speed random access memory, or may include a nonvolatile memory, for example, at least one magnetic disk storage device, a flash memory, or a universal flash storage (universal flash storage, UFS).

The electronic apparatus 100 may implement audio functions such as music playing and recording functions by using the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The audio module 170 may be further configured to encode and decode an audio signal. In some embodiments, the audio module 170 may be disposed in the processor 110, or some function modules of the audio module 170 are disposed in the processor 110.

The speaker 170A, also referred to as a “loudspeaker”, is configured to convert an audio electrical signal into a sound signal. The electronic apparatus 100 may listen to music or answer a handsfree call by using the speaker 170A.

The receiver 170B, also referred to as an “earpiece”, is configured to convert an audio electrical signal into a sound signal. When a call is answered or speech information is listened to by using the electronic apparatus 100, the telephone receiver 170B may be put close to a human ear to listen to speech.

The microphone 170C, also referred to as a “mike” or a “mic”, is configured to convert a sound signal into an electrical signal. When making a call or sending speech information, a user may make a sound by moving the mouth of the user close to the microphone 170C to input a sound signal to the microphone 170C. At least one microphone 170C may be disposed in the electronic apparatus 100. In some other embodiments, two microphones 170C may be disposed in the electronic apparatus 100, to implement a noise reduction function, in addition to collecting a sound signal. In some other embodiments, three, four, or more microphones 170C may alternatively be disposed in the electronic apparatus 100, to collect a sound signal, implement noise reduction, and identify a sound source, to implement a directional recording function and the like.

The headset jack 170D is configured to connect to a wired headset. The headset jack 170D may be the USB interface 130, a 3.5 mm open mobile terminal platform (open mobile terminal platform, OMTP) standard interface or a cellular telecommunications industry association of the USA (cellular telecommunications industry association of the USA, CTIA) standard interface.

The pressure sensor 180A is configured to sense a pressure signal, and may convert the pressure signal into an electrical signal. In some embodiments, the pressure sensor 180A may be disposed on the display 194. There are a plurality of types of pressure sensors 180A, such as a resistive pressure sensor, an inductive pressure sensor, and a capacitive pressure sensor. The capacitive pressure sensor may include at least two parallel plates made of conductive materials. When force is applied to the pressure sensor 180A, capacitance between electrodes changes. The electronic apparatus 100 determines intensity of pressure based on a change of the capacitance. When a touch operation acts on the display 194, the electronic apparatus 100 detects intensity of the touch operation based on the pressure sensor 180A. The electronic apparatus 100 may also calculate a touch location based on a detection signal of the pressure sensor 180A. In some embodiments, touch operations that are performed in a same touch position but have different touch operation strength may correspond to different operation instructions. For example, when a touch operation whose touch operation strength is less than a first pressure threshold is performed on a Messages icon, an instruction for viewing an SMS message is executed. When a touch operation whose touch operation strength is greater than or equal to the first pressure threshold is performed on the Messages icon, an instruction for creating an SMS message is executed.

The gyroscope sensor 180B may be configured to determine a motion posture of the electronic apparatus 100. In some embodiments, an angular velocity of the electronic apparatus 100 around three axes (namely, axes x, y, and z) may be determined by using the gyroscope sensor 180B. The gyroscope sensor 180B may be configured to implement image stabilization during photographing. For example, when the shutter is pressed, the gyroscope sensor 180B detects a shaking angle of the electronic apparatus 100; calculates, based on the angle, a distance that needs to be compensated for by a lens module; and enables the lens to counteract shaking of the electronic apparatus 100 through reverse motion, to implement image stabilization. The gyroscope sensor 180B may be further used in a navigation scenario and a motion-sensing game scenario.

The barometric pressure sensor 180C is configured to measure barometric pressure. In some embodiments, the electronic apparatus 100 calculates an altitude by using a barometric pressure value measured by the barometric pressure sensor 180C, to assist in positioning and navigation.

The magnetic sensor 180D includes a Hall effect sensor. The electronic apparatus 100 may detect opening and closing of a flip cover by using the magnetic sensor 180D. In some embodiments, when the electronic apparatus 100 is a flip phone, the electronic apparatus 100 may detect opening and closing of a flip cover based on the magnetic sensor 180D. Further, a feature such as automatic unlocking upon opening of the flip cover is set based on a detected opening or closing state of the flip cover.

The acceleration sensor 180E may detect values of accelerations of the electronic apparatus 100 in various directions (usually three axes). When the electronic apparatus 100 is static, a value and a direction of gravity may be detected. The acceleration sensor 180E may be further configured to identify a posture of the electronic apparatus, and is applied to applications such as horizontal and vertical screen switching and a pedometer.

The distance sensor 180F is configured to measure a distance. The electronic apparatus 100 may measure the distance by using infrared or a laser. In some embodiments, in a photographing scenario, the electronic apparatus 100 may measure the distance by using the distance sensor 180F, to implement fast focusing.

The optical proximity sensor 180G may include, for example, a light-emitting diode (LED) and an optical detector such as a photodiode. The light-emitting diode may be an infrared light-emitting diode. The electronic apparatus 100 emits infrared light by using the light emitting diode. The electronic apparatus 100 detects infrared reflected light from a nearby object by using the photodiode. When detecting sufficient reflected light, the electronic apparatus 100 may determine that there is an object near the electronic apparatus 100. When detecting insufficient reflected light, the electronic apparatus 100 may determine that there is no object near the electronic apparatus 100. The electronic apparatus 100 may detect, by using the optical proximity sensor 180G, that the user holds the electronic apparatus 100 to approach an ear to make a call, to automatically turn off a screen to save power. The optical proximity sensor 180G may also be used in a flip cover mode or a pocket mode to automatically unlock or lock the screen.

The ambient light sensor 180L is configured to sense ambient light brightness. The electronic apparatus 100 may adaptively adjust brightness of the display 194 based on the perceived ambient light brightness. The ambient light sensor 180L may be further configured to automatically adjust a white balance during photographing. The ambient light sensor 180L may further cooperate with the optical proximity sensor 180G to detect whether the electronic apparatus 100 is in a pocket, to prevent accidental touch.

The fingerprint sensor 180H is configured to collect a fingerprint. The electronic apparatus 100 may use a feature of the collected fingerprint to implement fingerprint unlocking, access an application lock, take a photo by using the fingerprint, answer an incoming call by using the fingerprint, and so on.

The temperature sensor 180J is configured to detect a temperature. In some embodiments, the electronic apparatus 100 executes a temperature processing policy by using the temperature detected by the temperature sensor 180J. For example, when the temperature reported by the temperature sensor 180J exceeds a threshold, the electronic apparatus 100 degrades performance of a processor near the temperature sensor 180J, to reduce power consumption for thermal protection. In some other embodiments, when the temperature is less than another threshold, the electronic apparatus 100 heats the battery 142, to prevent the electronic apparatus 100 from being abnormally powered off due to low temperature. In some other embodiments, when the temperature is less than still another threshold, the electronic apparatus 100 boosts an output voltage of the battery 142 to avoid abnormal shutdown due to a low temperature.

The touch sensor 180K is also referred to as a “touch panel”. The touch sensor 180K may be disposed on the display 194, and the touch sensor 180K and the display 194 form a touchscreen. The touch sensor 180K is configured to detect a touch operation performed on or near the touch sensor 180K. The touch sensor may transfer the detected touch operation to the application processor, to determine a type of a touch event. A visual output related to the touch operation may be provided on the display 194. In some other embodiments, the touch sensor 180K may alternatively be disposed on a surface of the electronic apparatus 100 in a position different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a human pulse, and receive a blood pressure beating signal. In some embodiments, the bone conduction sensor 180M may alternatively be disposed in a headset, to obtain a bone conduction headset. The audio module 170 may obtain a speech signal through parsing based on the vibration signal that is of the vibration bone of the vocal part and that is obtained by the bone conduction sensor 180M, to implement a speech function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch-sensitive button. The electronic apparatus 100 may receive key input, and generate key signal input related to user setting and function control of the electronic apparatus 100.

The motor 191 may generate a vibration prompt. The motor 191 may be configured to provide an incoming call vibration prompt or a touch vibration feedback. For example, touch operations performed on different applications (for example, photographing and audio playing) may correspond to different vibration feedback effects. The motor 191 may also correspond to different vibration feedback effects for touch operations performed on different areas of the display 194. Customization of a touch vibration feedback effect may also be supported.

The indicator 192 may be an indicator, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or plugged from the SIM card interface 195 to be in contact with or be separated from the electronic apparatus 100. The electronic apparatus 100 may support one or N SIM card interfaces, where N is a positive integer greater than 1. The SIM card interface 195 can support a nano-SIM card, a micro-SIM card, a SIM card, and the like. A plurality of cards can be simultaneously inserted into a same SIM card interface 195. The plurality of cards may have a same type, or may have different types. The SIM card interface 195 may be compatible with different types of SIM cards. The SIM card interface 195 may also be compatible with the external storage card. The electronic apparatus 100 interacts with a network by using the SIM card, to implement a call function, a data communication function, and the like. In some embodiments, the electronic apparatus 100 uses an eSIM, namely, an embedded SIM card. The eSIM card may be embedded into the electronic apparatus 100 and cannot be separated from the electronic apparatus 100.

A software system of the electronic apparatus 100 may use a layered architecture, an event-driven architecture, a microkernel architecture, a micro-service architecture, or a cloud architecture. In the embodiments of this application, an Android system with the layered architecture is used as an example to illustrate a software structure of the electronic apparatus 100.

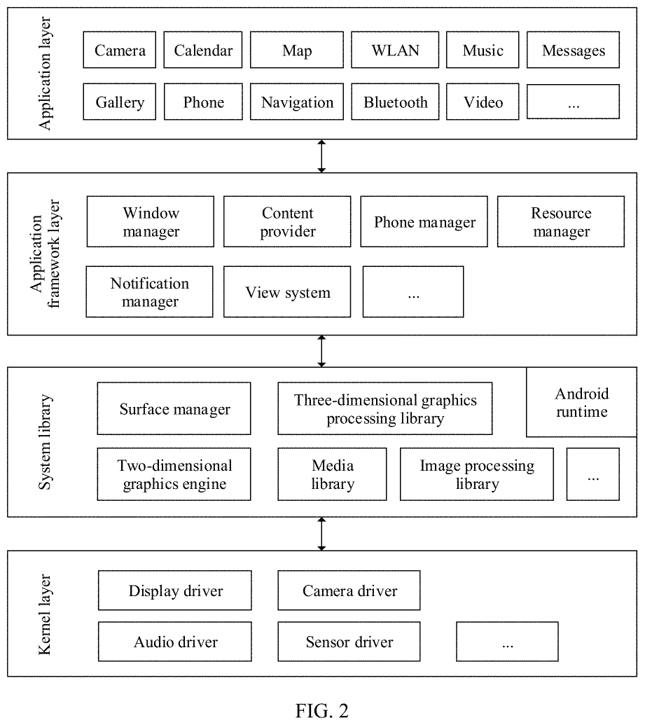

FIG. 2 is a block diagram of a software structure of an electronic apparatus 100 according to an embodiment of this application. In a layered architecture, software is divided into several layers, and each layer has a clear role and task. The layers communicate with each other through a software interface. In some embodiments, an Android system is divided into four layers: an application layer, an application framework layer, an Android runtime (Android runtime) and system library, and a kernel layer from top to bottom. The application layer may include a series of application packages.

As shown in FIG. 2, the application packages may include applications such as Camera, Gallery, Calendar, Phone, Map, Navigation, WLAN, Bluetooth, Music, Videos, and Messages.

The application framework layer provides an application programming interface (application programming interface, API) and a programming framework for an application at the application layer. The application framework layer includes some predefined functions.

As shown in FIG. 2, the application framework layer may include a window manager, a content provider, a view system, a phone manager, a resource manager, a notification manager, and the like.

The window manager is configured to manage a window program. The window manager may obtain a size of the display, determine whether there is a status bar, lock a screen, take a screenshot, and the like.

The content provider is configured to store and obtain data, and enable the data to be accessed by an application. The data may include a video, an image, audio, calls that are made and answered, a browsing history and a bookmark, a phone book, and the like.

The view system includes visual controls such as a control for displaying text and a control for displaying a picture. The view system may be configured to construct an application. A display interface may include one or more views. For example, a display interface including a notification icon of Messages may include a text display view and a picture display view.

The phone manager is configured to provide a communication function of the electronic apparatus 100, for example, management of a call status (including answering, declining, or the like).

The resource manager provides various resources such as a localized character string, an icon, a picture, a layout file, and a video file for an application.

The notification manager enables an application to display notification information in a status bar, and may be configured to convey a notification type message. The displayed notification information may automatically disappear after a short pause without user interaction. For example, the notification manager is configured to notify download completion, provide a message notification, and the like. The notification manager may alternatively be a notification that appears in a top status bar of the system in a form of a graph or a scroll bar text, for example, a notification of an application running on the background or a notification that appears on a screen in a form of a dialog window. For example, text information is prompted at the status bar, a prompt tone is made, the electronic apparatus vibrates, or the indicator flickers.

The Android runtime includes a kernel library and a virtual machine. The Android runtime is responsible for scheduling and management of the Android system.

The kernel library includes two parts: a function that needs to be invoked in java language and a kernel library of Android.

The application layer and the application framework layer run on the virtual machine. The virtual machine executes Java files at the application layer and the application framework layer as binary files. The virtual machine is configured to implement functions such as object lifecycle management, stack management, thread management, security and exception management, and garbage collection.

The system library may include a plurality of function modules, for example, a surface manager (surface manager), a media library (Media Library), a three-dimensional graphics processing library (for example, OpenGL ES), and a 2D graphics engine (for example, SGL).

The surface manager is configured to manage a display subsystem and provide fusion of 2D and 3D layers for a plurality of applications.

The media library supports playback and recording in a plurality of commonly used audio and video formats, static image files, and the like. The media library may support a plurality of audio and video coding formats, such as MPEG-4, H.264, MP3, AAC, AMR, JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

In this embodiment of this application, as shown in FIG. 2, the system library may further include an image processing library. After the camera application is started, the camera application may obtain an image collected by the electronic apparatus. After obtaining a region of each object, the image processing library may retain pixel values of pixels in regions of one or more particular objects, and convert pixel values of pixels in a region other than the regions of the one or more particular objects into grayscale values, to retain a color of an entire region of a particular object.

The terminal in the structures shown in FIG. 1 and FIG. 2 may be configured to perform the image processing method provided in the embodiments of this application. For ease of understanding, in the following embodiment of this application, the image processing method in a photographing scenario provided in the embodiments of this application is specifically described with reference to the accompanying drawings by using a mobile phone having the structures shown in FIG. 1 and FIG. 2 as an example.

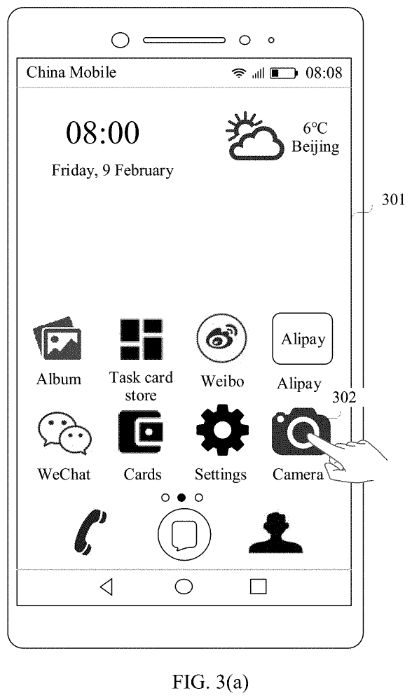

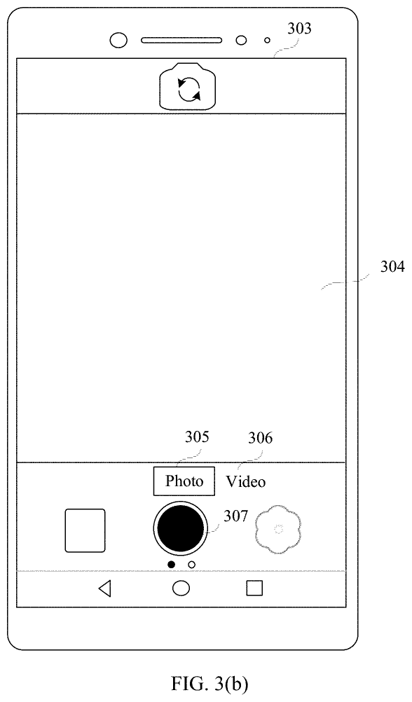

FIG. 3(a) shows a graphical user interface (graphical user interface, GUI) of a mobile phone, and the GUI is a desktop 301 of the mobile phone. When detecting an operation that a user taps an icon 302 of a camera application (application, APP) on the desktop 301, the mobile phone may start the camera application, and display another GUI shown in FIG. 3(b). The GUI may be referred to as a photographing interface 303. The photographing interface 303 may include a viewfinder frame 304. In a preview state, the viewfinder frame 404 may display a preview image in real time. It may be understood that the viewfinder frame 304 may have different sizes in a photo mode and a video mode (that is, a video photographing mode). For example, the viewfinder frame shown in FIG. 3(b) may be a viewfinder frame in a photo mode. In a video mode, the viewfinder frame 304 may be an entire touchscreen.

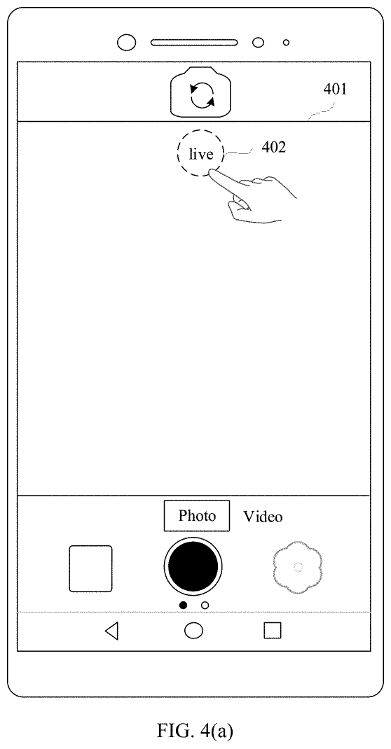

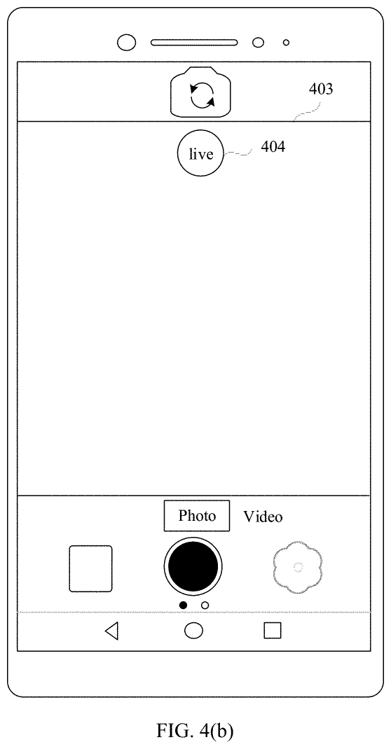

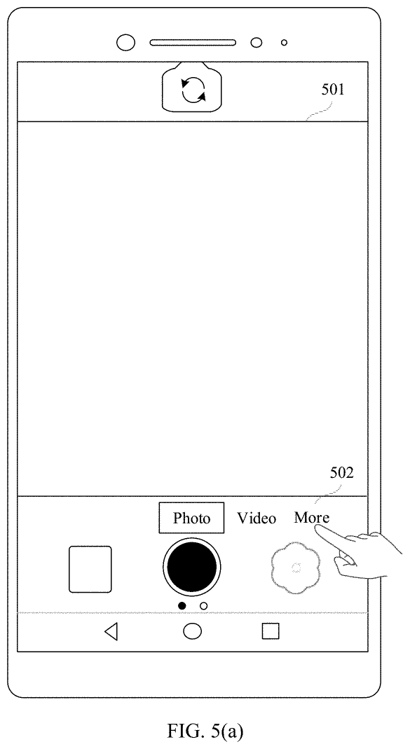

For example, as shown in FIG. 3(b), after the mobile phone starts the camera, the viewfinder frame 304 may display an image. In addition, the photographing interface may further include a control 305 used to indicate the photo mode, a control 306 used to indicate the video mode, and a photographing control 307. In the photo mode, after the mobile phone detects an operation that the user taps the photographing control 307, the mobile phone performs a photo taking operation. In the video mode, after the mobile phone detects an operation that the user taps the photographing control 307, the mobile phone performs a video photographing operation. Optionally, in the photo mode, a static picture or a dynamic picture (live photo) may be photographed. FIG. 4(a) shows another GUI of the mobile phone, where the GUI is an interface 401 of a static picture photographing mode. After the mobile phone starts the camera, in the photo mode, the photographing interface of the static picture photographing mode may further include a control 402 used to indicate to photograph a dynamic picture. When detecting that a user taps the control 402, the mobile phone switches from the static picture photographing mode to a dynamic picture photographing mode, and displays another GUI shown in FIG. 4(b), where the GUI is an interface 403 of the dynamic picture photographing mode. Similarly, after the mobile phone starts the camera, in the photo mode, the photographing interface of the dynamic picture photographing mode may further include a control 404 used to indicate to photograph a static picture. When detecting that the user taps the control 404, the mobile phone switches from the dynamic picture photographing mode to the static picture photographing mode, and displays the GUI shown in FIG. 4(a). Optionally, the control 402 and the control 404 may have a same icon, and are distinguished by highlight with color. Optionally, the control 402 and the control 404 may have a same icon, and are distinguished by different types of lines, for example, a solid line and a dotted line, or a thick line and a thin line.

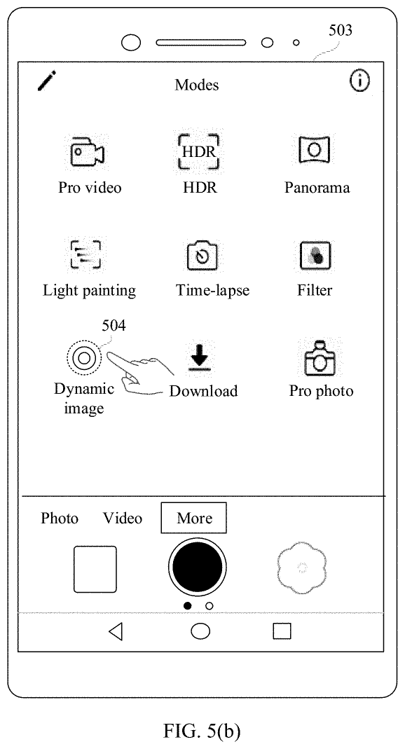

In a specific implementation process, there are a plurality of optional designs for entering the GUI of the dynamic picture photographing mode. For example, as shown in FIG. 5(a), a photographing interface 501 further includes a control 502 used to indicate to display more other modes. When the mobile phone detects that the user selects the photographing control 502, for example, the user taps the photographing control 502, or the mobile phone detects that the user slides the photographing control 502 to a center of the GUI, or the mobile phone detects that the user slides the photographing control 502 to the above of a photographing key, the mobile phone displays a GUI shown in FIG. 5(b). The GUI is an interface 503, and the interface 503 displays a plurality of controls used to indicate a specific photographing mode, including a control 504 used to indicate the dynamic picture photographing mode. When detecting that the user taps the photographing control 504, the mobile phone displays the photographing interface 501 and enters the dynamic picture photographing mode.

It should be understood that the image processing method provided in the embodiments of this application may be applied to a scenario in which a static picture, a dynamic picture, and a video are photographed and processed. For ease of description, video photographing is used as an example for description in the embodiments of this application.

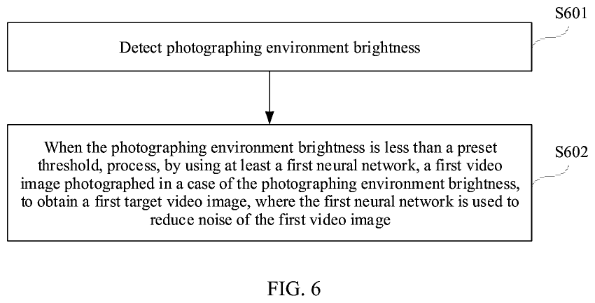

FIG. 6 is a schematic flowchart of an image processing method according to an embodiment of this application. The image processing method may be performed by a terminal, or may be performed by a chip inside the terminal. As shown in FIG. 6, the method 600 includes the following steps.

S601: Detect photographing environment brightness during video photographing.

Herein, the photographing environment brightness may also be understood as photographing illuminance. In a specific implementation process, the detection operation may have the following optional implementations.

Optionally, an ambient light sensor detects the photographing environment brightness, and outputs a corresponding measurement result, for example, a measured brightness value, a quantized brightness value, a constant indicating a brightness range, or indication signals corresponding to different measurement results. A processor receives the measurement result by using an interface circuit, to obtain the photographing environment brightness.

Optionally, photosensibility (photosensibility), which is also referred to as an ISO (international standardization organization) value, and/or exposure time are/is detected. The photographing environment brightness is determined based on the ISO value, and/or the exposure time, and/or an aperture size. Specifically, a relationship between the brightness I, the ISO value, and the exposure time tₑₓₚₒₛᵤᵣₑ is

$$I = \frac{1}{ISO \cdot {t}_{exposure}} .$$

To be specific, the brightness becomes lower as the exposure time increases and/or the ISO value increases.

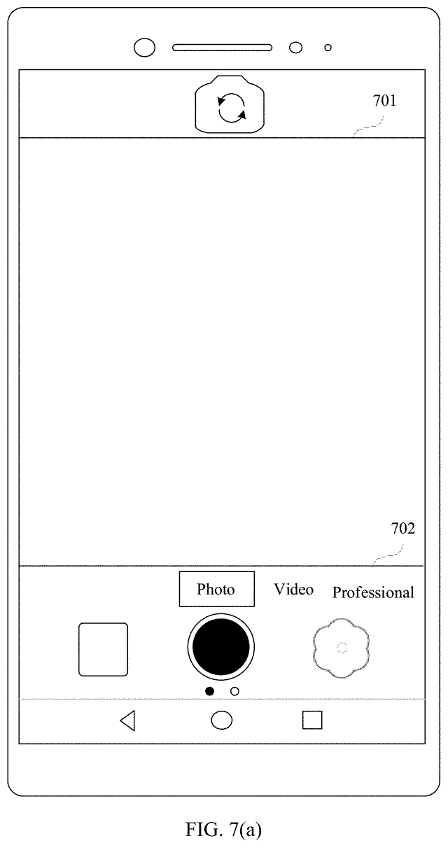

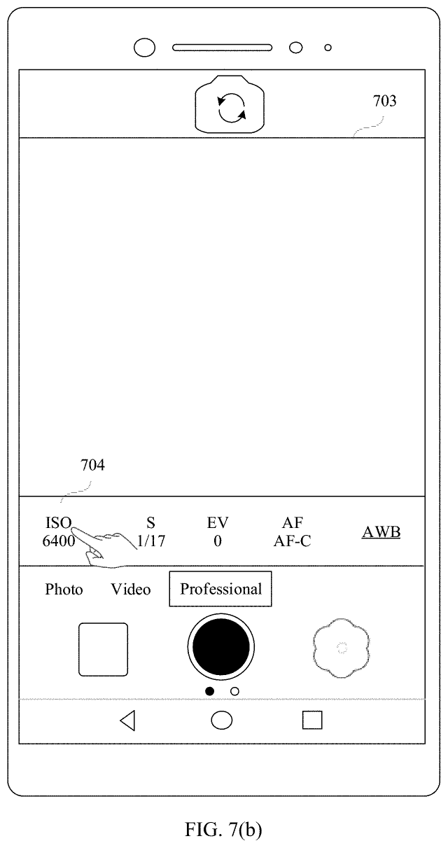

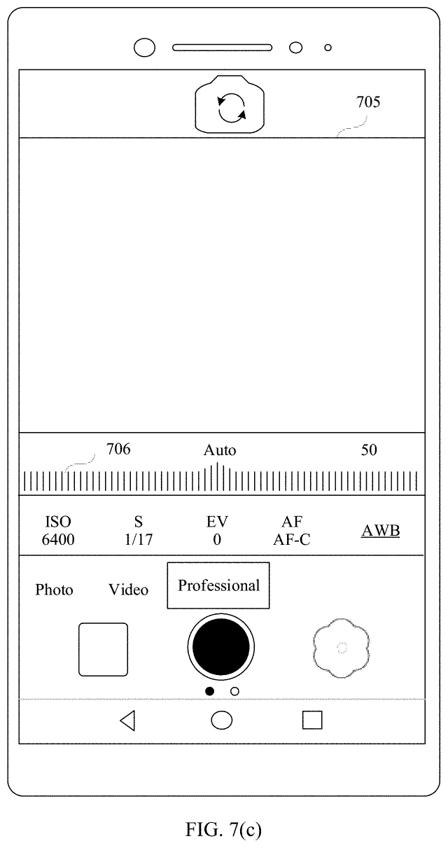

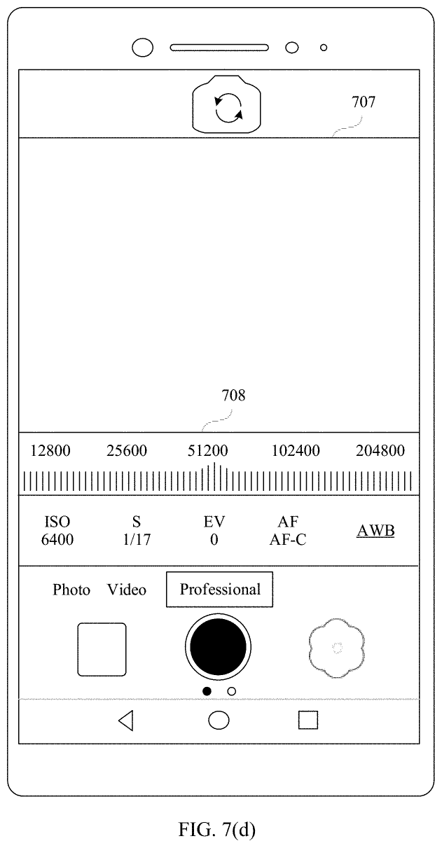

The ISO value may be detected by hardware of the terminal, or may be manually set by a user. For example, as shown in FIG. 7(a), a photographing interface 701 further includes a control 702 used to indicate a user to manually set a photographing parameter mode. When detecting that the user selects the control 702, the mobile phone displays a GUI shown in FIG. 7(b). The GUI is an interface 703 for the user to manually set a photographing parameter, and the interface 703 includes a control 704 used to indicate the ISO value. Optionally, the control 704 may display an ISO value in a current photographing parameter. Optionally, when detecting that the user taps the control 704, the mobile phone displays a GUI shown in FIG. 7(c). The GUI is an interface 705 for the user to manually set the ISO value, and the interface 705 may show a current photographing mode, for example, automatically setting an ISO value mode, or manually setting an ISO value mode (for example, displaying the ISO value). Optionally, the interface 705 includes a slide 706 used to indicate a current ISO value. For example, an ISO value or an ISO value mode used for current photographing is shown by a pointing direction at a center of the slide 706, a pointing direction at a bold location of the slide 706, a pointing direction at a highlight location of the slide 706, or a pointing direction at a protruded location of the slide 706. Herein, the slide 706 may be slid leftwards and rightwards. The user may manually set the ISO value and mode by sliding the slide 706, or may input the ISO value. When the user slides the slide 706, a GUI shown in FIG. 7(d) is displayed. The GUI is an interface 707 for the user to manually set the ISO value, and an ISO value indicated by the slide 706 in the interface 707 is an ISO value used for current photographing.

Optionally, average image brightness of a photographed video image is detected.

S602: When the photographing environment brightness is less than a preset threshold, process, by using at least a first neural network, a first video image photographed in a case of the photographing environment brightness, to obtain a first target video image, where the first neural network is used to reduce noise of the first video image.

It should be understood that the first neural network includes but is not limited to a convolutional neural network. A neural network (for example, a convolutional neural network) can improve a video image processing effect through deep learning. Particularly, for a video image with high-frequency noise, the image processing method provided in this application can be used to optimize the video image to obtain clearer detail information of the video image.

It should be understood that the photographing environment brightness is compared with a threshold in S602 in a plurality of optional implementations. For example, measured photographing environment brightness is directly compared with a threshold; or a quantization result of the measured photographing environment brightness is compared with a threshold; or exposure time is compared with a time threshold; or an ISO value set by the user or an ISO value automatically set by the mobile phone is compared with a threshold. Specifically, for example, an ISO threshold is set to 51200. When the ISO value set by the user is 58000, it is considered that the photographing environment brightness is less than the threshold, and a video is processed based on the first neural network. When the ISO value set by the user is 50, it is considered that the photographing environment brightness is greater than the threshold, and a video is processed based on the first neural network.

Further, optionally, a second neural network may be used to process a video image photographed in a low illuminance or dark light condition. The second neural network is used to optimize a dynamic range of the first video image.

Specifically, for example, a brightness histogram of the first video image is made uniform by using the second neural network, which includes but is not limited to improving brightness of a part whose darkness is excessively low, and reducing brightness of a part whose brightness is excessively high.

Optionally, before the first video image is processed by using a neural network (for example, the first neural network or the second neural network), other processing may be performed on the first video image by using another algorithm, for example, a BM3D denoising algorithm or a non-local mean (non-local mean) algorithm. In the non-local mean algorithm, all pixels in an image may be used to perform weighted averaging based on similarity. The foregoing other processing may include but is not limited to denoising, dynamic range adjustment, contrast improvement, color adjustment, and the like.

Optionally, a value range of a photographing frame rate corresponding to the first video image includes [24, 30] frames per second (frame per second, fps), for example, 25 fps. In other words, when the photographing environment brightness is less than the preset threshold (for example, in a low illuminance or dark light photographing environment), a frame rate at which a camera of the terminal photographs a video image may include [24, 30] fps, for example, 25 fps. In this case, the video image photographed by the camera may include the first video image.

As the photographing environment brightness decreases, perception of human eyes for a photographing frame rate and a display frame rate of a video image may be reduced. However, because a lowest display frame rate at which the human eyes can perceive a coherent picture is 24 fps, the photographing frame rate corresponding to the first video image may be limited to a proper range that can be perceived by the human eyes, to reduce power consumption of the terminal.

The preset threshold may be less than or equal to 5 lux, for example, 0.2 lux or 1 lux.

Optionally, the method 600 further includes the following step.

S603: When the photographing environment brightness is greater than or equal to the preset threshold, perform, by using a first preset denoising algorithm, denoising processing on a second video image photographed in the case of the photographing environment brightness, to obtain a second target video image, where the first preset denoising algorithm does not include a neural network.

Herein, the first preset denoising algorithm may be understood as a conventional computer image processing method, for example, but not limited to a BM3D denoising algorithm or a non-local mean algorithm.

Optionally, when the photographing environment brightness is greater than or equal to the preset threshold, another preset algorithm that does not include a neural network is used to perform denoising processing on the second video image photographed in the case of the photographing environment brightness, to obtain the second target video image. The preset algorithm may be used to adjust a dynamic range, improve contrast, adjust color, and so on. The preset algorithm may include but is not limited to histogram equalization, gamma transformation, and exponential transformation.

A value of the photographing frame rate corresponding to the first video image should be less than a value of a photographing frame rate corresponding to the second video image.

Optionally, a value range of the photographing frame rate corresponding to the second video image includes [30, 60] fps. In other words, when the photographing environment brightness is greater than or equal to the preset threshold (for example, in a low illuminance or highlight photographing environment), a frame rate at which the camera of the terminal photographs a video image may include [30, 60] fps, for example, 60 fps. In this case, the video image photographed by the camera may include the second video image.

It should be understood that a photographing frame rate is related to exposure time. In a high illuminance or high photographing environment brightness condition, when the exposure time is short, a higher photographing frame rate may be achieved. A video image photographed by using a higher photographing frame rate can improve visual experience of a user.

Herein, it should be understood that S602 and S603 may be separately performed, or may be concurrently performed, or may be alternately performed in a change process of the photographing environment brightness.

It should be understood that a neural network (for example, the first neural network or the second neural network), including a CNN, may be understood as an AI computer image processing method. Because the neural network requires a large quantity of computing units, optionally, a processing process of the method may be accelerated by using an accelerator (for example, an NPU or a GPU) to ensure real-time quality. However, this also causes extra power consumption, which may shorten standby time. Therefore, an adaptive method is selected based on the photographing environment brightness to process a video. When the neural network such as the CNN processes a video, video contrast can be improved while video brightness is improved, to reserve more image details. However, because a large quantity of computing units are required for using the neural network, when the photographing environment brightness is relatively high, the first preset denoising algorithm may be used to reduce power consumption of the terminal.

Optionally, the method 600 further includes the following step.

S604: Enter a first photographing mode, where the first photographing mode is used to indicate the terminal to detect the photographing environment brightness.

In a specific implementation process, a condition for triggering to enter the first photographing mode has a plurality of possible implementation methods.

### Example 1

An operation of a user is detected to determine whether to enter the first photographing mode, for example, a gesture operation of the user, input of a speech instruction, a knuckle operation, a tapping operation, or a value that is of a related photographing parameter and that is set by the user enters a predefined trigger range, where the photographing parameter includes but is not limited to one or more of an ISO value, exposure time, and an aperture size.

Several possible examples are provided below. When detecting that the user sets, in the user interface 707, the ISO value to be less than 12800, the terminal determines to enter the first photographing mode; or when detecting a speech instruction, of the user, of “enabling a night photographing mode”, the terminal determines to enter the first photographing mode; or when detecting that the user draws a “Z”-shaped image by using a knuckle, the terminal determines to enter the first photographing mode; or when detecting that the user taps a control used to indicate to enable the first photographing mode, the terminal determines to enter the first photographing mode.

### Example 2

It is detected whether photographing is performed in a low illuminance or dark light condition, to determine whether to enter the first photographing mode.

Specifically, this includes but is not limited to detecting a photographing parameter, and/or sensing information of an ambient light sensor, and/or a parameter of a photographed image, to determine whether to enter the first photographing mode. The photographing parameter includes but is not limited to one or more of an aperture size, exposure time, and an ISO value. The parameter of the photographed image includes but is not limited to average brightness of the image.

Specifically, for example, when the terminal detects that the sensing information of the ambient light sensor indicates that the terminal is in the low illuminance or dark light condition, the terminal automatically enters the first photographing mode, and starts to detect the photographing environment brightness. For example, when detecting that a current photographing parameter, that is, the ISO value, is greater than a specific parameter (for example, 50000), the terminal considers that the terminal is in the low illuminance or dark light condition, the terminal automatically enters the first photographing mode, and starts to detect the photographing environment brightness. For example, when detecting that the average brightness of the photographed image is less than a specific parameter, the terminal considers that the terminal is in the low illuminance or dark light condition, the terminal automatically enters the first photographing mode, and starts to detect the photographing environment brightness.

It should be understood that the foregoing detection operation may be real-time detection in a photographing process, and when it is detected that the foregoing trigger condition exists, the terminal enters the first photographing mode.

The method described in S601 to S604 may be used to process a single frame of video image or a plurality of frames of video images. The plurality of frames of video images include but are not limited to a plurality of consecutive frames of video images or a plurality of frames of video images spaced apart (such as a plurality of frames of video images spaced by an equal interval).

Optionally, when it is determined that photographing environment brightness of an i^{th} frame of video image in the photographed video image is less than the preset threshold, the i^{th} frame of video image is processed by using the first neural network and/or the second neural network, where i is greater than 1.

Optionally, when it is determined that average photographing environment brightness of an i^{th} frame of video image to a j^{th} frame of video image in the photographed video image is less than the preset threshold, the i^{th} frame of video image to the i^{th} frame of video image are processed by using the first neural network and/or the second neural network, where 1≤i≤j≤N.

Optionally, when it is determined that photographing environment brightness of an i^{th} frame of video image in the photographed video image is less than the preset threshold, a k^{th} frame of video image to a j^{th} frame of video image are processed by using the first neural network and/or the second neural network, where 1≤k≤i≤j≤N.

Optionally, when it is determined that photographing environment brightness of an i^{th} frame of video image in the photographed video image is less than the preset threshold, the i^{th} frame of video image to an N^{th} frame of video image are processed by using the first neural network and/or the second neural network, where 1≤i≤N.

Optionally, when it is determined that photographing environment brightness of an i^{th} frame of video image in the photographed video image is less than the preset threshold, all video images are processed by using the first neural network and/or the second neural network, where 1≤i≤N.

Optionally, when it is determined that average photographing environment brightness of an i^{th} frame of video image to a j^{th} frame of video image in the photographed video image is less than the preset threshold, all video images are processed by using the first neural network and/or the second neural network, where 1≤i≤j≤N.

It should be understood that the camera of the terminal may photograph a series of video images to obtain a video stream. Content displayed in a photographing interface (also referred to as a preview interface) is a preview stream. A series of video images stored after photographing is completed may be referred to as a record stream, including the first target video image and/or the second target video image that are/is obtained by using the method 600. The i^{th} frame of video image is any frame of video image in the video stream, where i is less than or equal to a total quantity N of frames in the video stream.

Optionally, a video image that is in an original video stream and that has a same frame number as the first target video image and/or the second target video image may be replaced by the first target video image and/or the second target video image to obtain a target video. It should be understood that the preview stream may include a target video image. To reduce power consumption, the preview stream and the record stream may be inconsistent.

Optionally, the method 600 further includes S605 in which a video image photographed in a case of current photographing environment brightness is displayed.

Optionally, the method 600 further includes S606 in which the first target video image is displayed.

Optionally, the method 600 further includes S607 in which the second target video image is displayed.

It may be understood that in a specific implementation process, considering power consumption of the terminal and a difference in a visual effect for the user, there may be a plurality of implementations. Several example designs are provided herein to help understand.

Example 1: A video image currently photographed by the camera is displayed in a photographing interface. The first target video image and/or the second target video image are/is stored in a memory. When it is detected that the user chooses to play the first target video image and/or the second target video image, the corresponding video image is then displayed. When this method is used, during photographing, the user cannot perceive an effect obtained after video processing, but power consumption of the terminal can be reduced and standby time of the terminal can be prolonged.

Example 2: The second target video image is displayed in a photographing interface. The first target video image is stored in a memory. When it is detected that the user chooses to play the first target video image, the corresponding video image is then displayed. When this method is used, during photographing by the user, a preview effect is better than direct display of a video image photographed by the camera. In addition, power consumption of the terminal can be reduced and standby time of the terminal can be prolonged.

Example 3: The first target video image is displayed in a photographing interface. When this method is used, a visual effect for the user can be improved, but extra power consumption is also brought, and standby time of the terminal is shortened. Optionally, a processing process of a neural network may be accelerated by using an NPU, to improve continuity of a preview effect in the photographing interface.

The first neural network and the second neural network may be obtained by using the following example training method: A plurality of video images with different noise are used as training samples, and the video images are labelled. The plurality of different video images with noise are combined to obtain a clean video image, the clean video image is used as a target (label), and training is performed by using a deep learning algorithm, to obtain a result close to the target and obtain a corresponding neural network model. The different noise includes high-frequency noise and low-frequency noise. Specifically, the deep learning algorithm may include but is not limited to a U-Net algorithm or a ResNet algorithm. To reduce implementation difficulty, the foregoing video image may be obtained by the camera through static photographing, to obtain a video image without an offset. A training effect may be evaluated by calculating a loss parameter of the image, for example, a minimum mean square error (minimum mean square error, MMSE), an L1 norm, or a perception loss (perception loss).

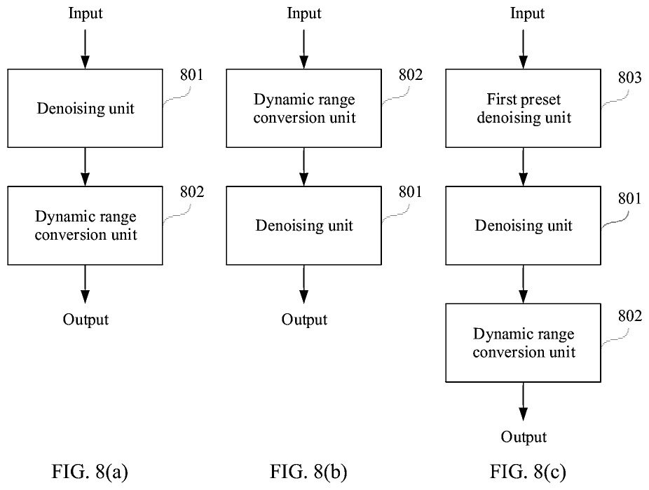

As shown in FIG. 8(a), FIG. 8(b), and FIG. 8(c), example neural network designs including the first neural network and the second neural network are provided herein. The first neural network includes a denoising unit 801, and the second neural network includes a dynamic range conversion unit 802. Optionally, the neural network is shown in FIG. 8(a). An image may be first denoised by using the denoising unit 801, and then a dynamic range of the image is adjusted by using the dynamic range conversion unit 802. Optionally, the neural network is shown in FIG. 8(b). A dynamic range of an image may be first adjusted by using the dynamic range conversion unit 802, and then the image is denoised by using the denoising unit 801. Optionally, the neural network may further include: An image is processed by using a first preset denoising unit 803, and then processed by using the denoising unit 801 and the dynamic range conversion unit 802. In this way, an image processing effect can be further improved. Similarly, a sequence of processing performed by the denoising unit 801 and the dynamic range conversion unit 802 is not limited herein. The denoising unit 801 and/or the dynamic range conversion unit 802 use/uses a CNN algorithm. The denoising unit may also be referred to as a filter (filter), and the dynamic range conversion unit may also be referred to as a dynamic range converter (dynamic range converter).

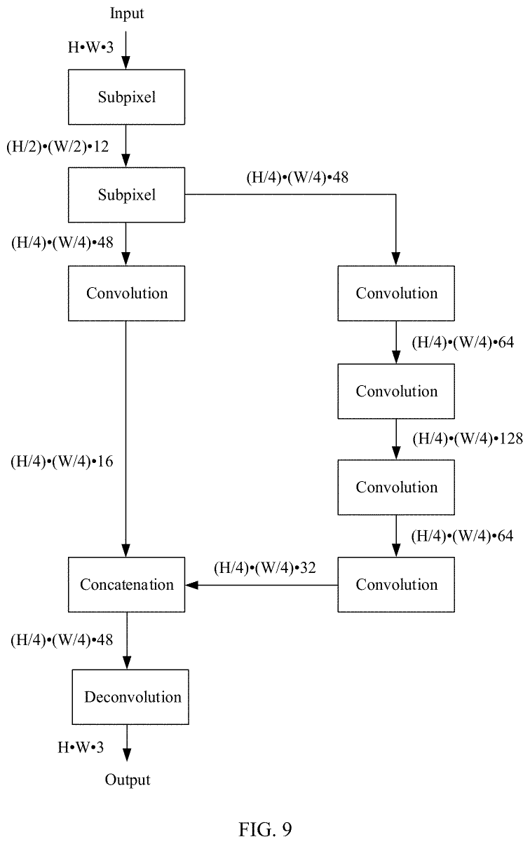

FIG. 9 shows an example design of a network architecture of a denoising unit according to an embodiment of this application. As shown in FIG. 9, an image is input by using an array structure including input resolution and an input channel quantity N₁. In a specific implementation process, the input resolution is in a form of length H×width W, and a value of the input channel quantity N₁ may be set based on an actual situation. For example, a common image includes three channels of red (red, R), green (green, G), and blue (blue, B), or includes three channels of brightness (Y), color (U), and concentration (V). In this case, the value of the input channel quantity N₁ is 3. Similarly, an image processed by the denoising unit is also output by using an array structure including target resolution and an output channel quantity M₁. In a specific implementation process, the target resolution is also in a form of length×width, and a value of the output channel quantity M₁ may be set based on an actual situation. In FIG. 9, an example in which the input channel quantity N₁ is 3 and the output channel quantity M₁ is 3 is used.

The denoising unit may include a subpixel (subpixel) subunit, a convolution (convolution) subunit, a concatenation (concate) subunit, and a deconvolution (deconvolution) subunit. A convolution kernel of the convolution subunit includes but is not limited to 3×3.

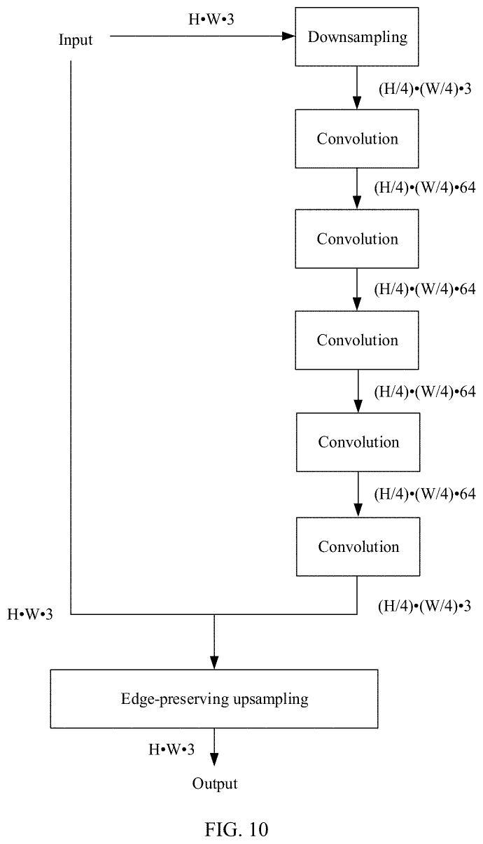

FIG. 10 shows an example design of a network architecture of a dynamic range conversion unit according to an embodiment of this application. As shown in FIG. 10, an image is input by using an array structure including input resolution and an input channel quantity N₂. In a specific implementation process, the input resolution is in a form of length H×width W, and a value of the input channel quantity N₂ may be set based on an actual situation. For example, a common image includes three channels R, G, and B. In this case, the value of the input channel quantity N₂ is 3. Similarly, an image processed by using the denoising unit is also output by using an array structure including target resolution and an output channel quantity M₂. In a specific implementation process, the target resolution is also in a form of length×width, and a value of the output channel quantity M₂ may be set based on an actual situation. In FIG. 9, an example in which the input channel quantity N₂ is 3 and the output channel quantity M₂ is 3 is used.

The dynamic range conversion unit may include a downsampling (downsampling) subunit, a convolution subunit, and an upsampling (upsampling) subunit. The upsampling subunit performs edge-preserving upsampling, and may be specifically implemented by a filter such as a guided filter (guided filter) or a bilateral filter (bilateral filter).

Optionally, to reduce overhead herein, the denoising unit and/or the dynamic range conversion unit may include only a brightness channel. In this case, the input channel quantity is 1, and the output channel quantity is 1. It should be understood that the output channel quantity of the denoising unit should be consistent with the input channel quantity of the dynamic range conversion unit based on a sequence of image processing. For example, an image is first processed by using the denoising unit, and then processed by using the dynamic range conversion unit. In this case, if the input channel quantity of the denoising unit is 3 and the output channel quantity is 1, the input channel quantity of the dynamic range conversion unit is 1 and the output channel quantity is 1.

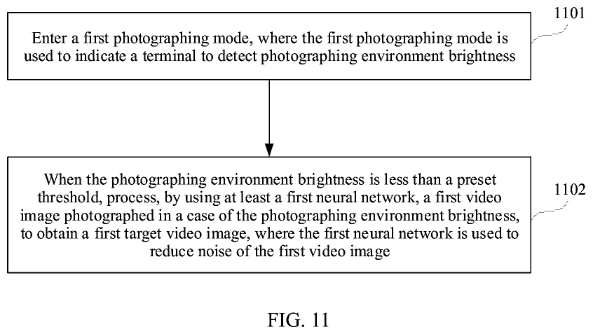

FIG. 11 is a schematic flowchart of another image processing method according to an embodiment of this application. The image processing method may be performed by a terminal, or may be performed by a chip inside the terminal. As shown in FIG. 11, the method 1100 includes the following steps.

S1101: Enter a first photographing mode, where the first photographing mode is used to indicate the terminal to detect photographing environment brightness.

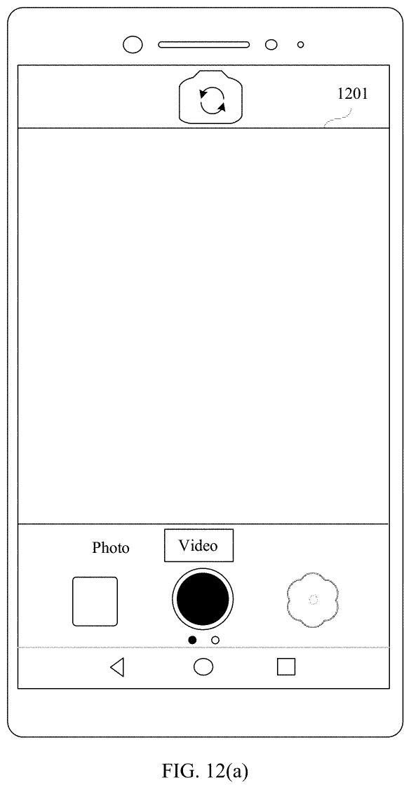

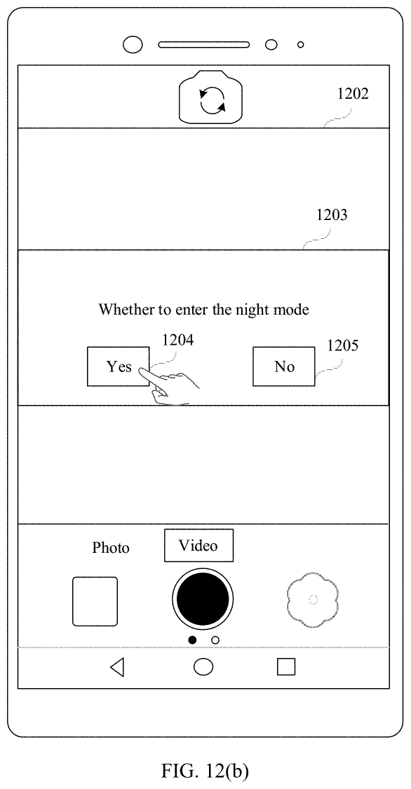

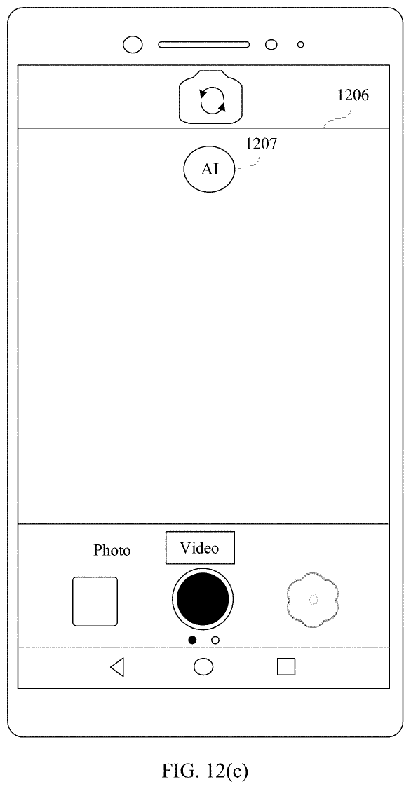

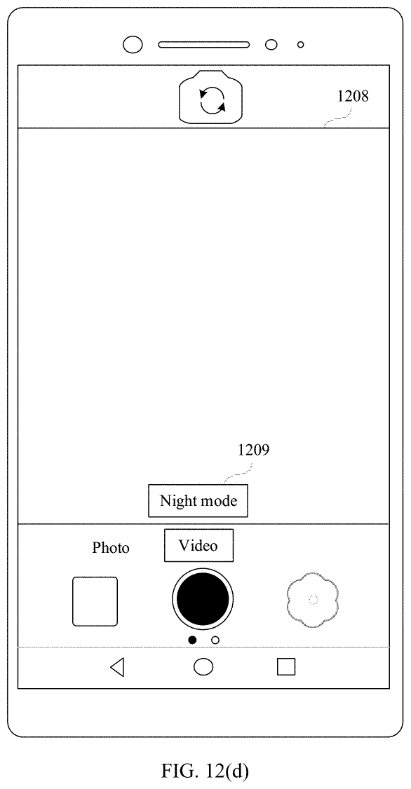

Optionally, the photographing environment brightness is detected, and when the photographing environment brightness is less than a threshold, it is considered that a night photographing mode is entered. For a method for detecting the photographing environment brightness, refer to related description in S601 in FIG. 6. Details are not described herein again. Further, optionally, in a photographing process, for example, a mobile phone displays a GUI shown in FIG. 12(a). When the photographing environment brightness is less than the threshold, a GUI shown in FIG. 12(b) is displayed. The GUI is an interface 1202 used to indicate selection of a night mode, and the interface 1202 includes a dialog box 1203. The dialog box 1203 includes a control 1204 used to indicate to enter the night mode, and a control 1205 used to indicate not to enter the night mode is not entered. A location of the dialog box may be in an upper part, a middle part, or a lower part of a screen. When detecting that a user taps the control 1204, the mobile phone enters the night mode.

Optionally, when detecting that the user taps the control 1204, the mobile phone displays a GUI shown in FIG. 12(c). The GUI is an interface 1206 used to indicate to use an artificial intelligence algorithm photographing mode. In this embodiment of this application, using the artificial intelligence algorithm photographing mode may also be understood as using the night mode. The interface 1206 includes a control 1207 used to indicate to select or exit the artificial intelligence algorithm photographing mode. In the artificial intelligence algorithm photographing mode, when detecting that the user taps the control 1207, the mobile phone exits the artificial intelligence algorithm photographing mode.

Optionally, when detecting that the user taps the control 1204, the mobile phone displays a GUI shown in FIG. 12(d). The GUI is an interface 1208 used to indicate to use the night photographing mode, and the interface 1208 includes a control 1209 used to indicate to select or exit the night mode. In the night photographing mode, when detecting that the user taps the control 1209, the mobile phone exits the night photographing mode.

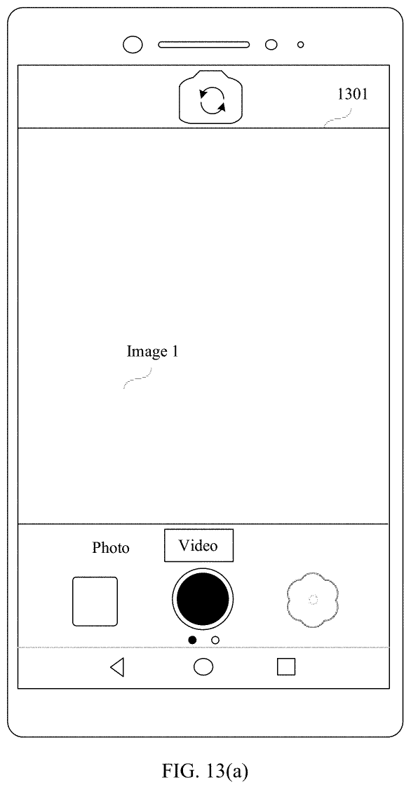

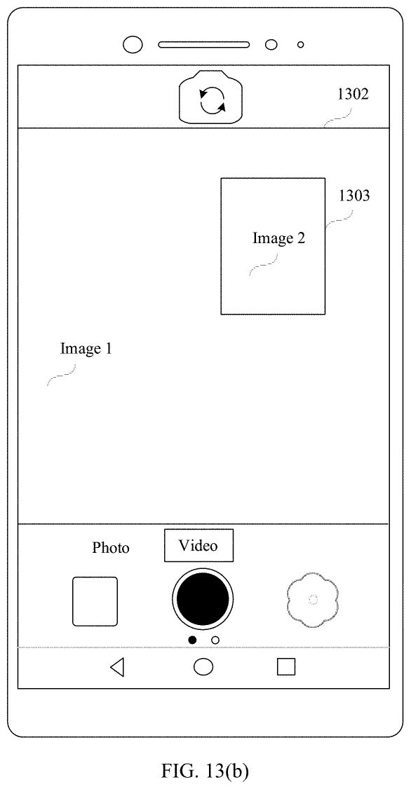

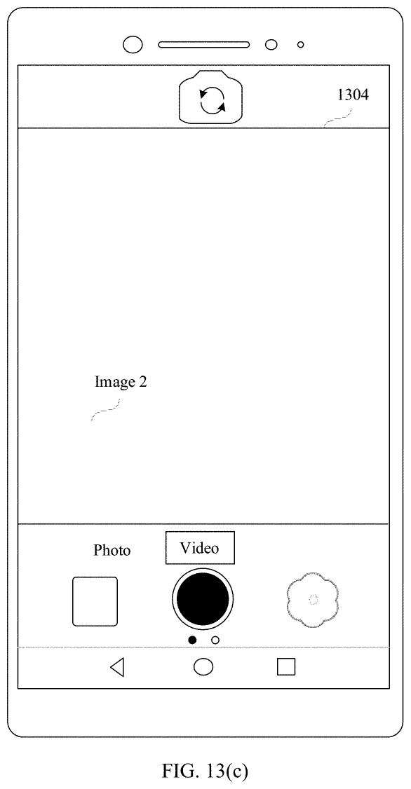

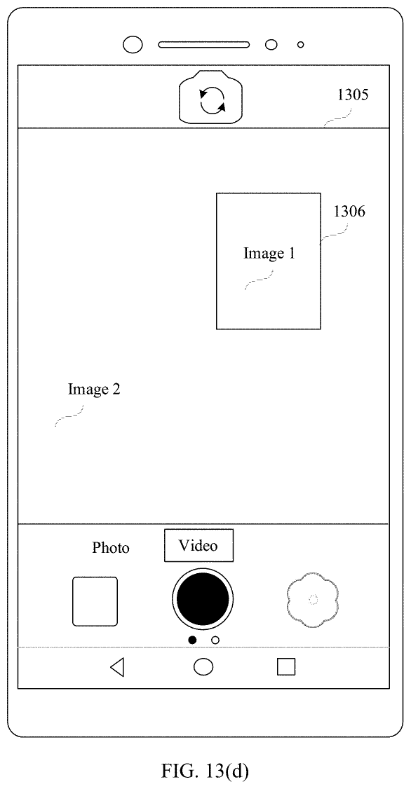

Optionally, in the photographing process, for example, the mobile phone displays a GUI shown in FIG. 13(a). The GUI is an interface 1301, and the interface 1301 displays a currently photographed video image or dynamic picture, which is referred to as an image 1 herein. When the photographing environment brightness is less than the threshold, a GUI shown in FIG. 13(b) is displayed. The GUI is an interface 1302 used to display effect graphs of two different processing manners, and the interface 1302 includes the image 1, and a control 1303 used to display an image (herein referred to as an image 2) processed by a neural network. Different images (the image not processed by the neural network and the image processed by the neural network) are displayed, so that the user can intuitively perceive a difference in an image processing effect. Optionally, the user may tap the control 1303 to choose to enter the night photographing mode. Optionally, the user may use a preset gesture operation such as sliding downwards, sliding leftwards, or double-tapping, to choose to enter the night photographing mode. Herein, the preset gesture operation may be predefined before delivery, or may be predefined by the user in setting. Further, optionally, the night photographing mode is entered, and a GUI shown in FIG. 13(c) is displayed. The GUI is an interface 1301 for displaying the image 2. Optionally, the night photographing mode is entered, and a GUI shown in FIG. 13(d) is displayed. The GUI is an interface 1305 used to display effect graphs of two different processing manners. The interface 1305 includes the image 2 and a control 1306 used to display an image (namely, the image 1) not processed by the neural network. Optionally, the user may select the control 1306 to exit the night photographing mode.

Optionally, a photographing mode selected by the user may be detected. For example, in the photographing process, when the mobile phone detects that the user taps the control 1207 or the control 1209, it is considered that the mobile phone enters a corresponding mode. Alternatively, for example, in the photographing process, the mobile phone detects a speech command of the user, where the speech command indicates the mobile phone to enter the night photographing mode.

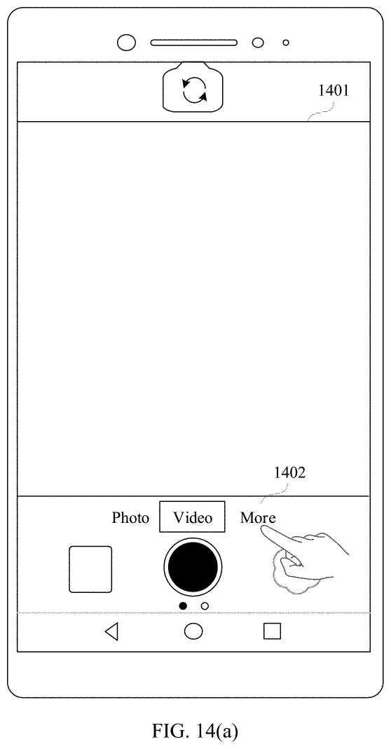

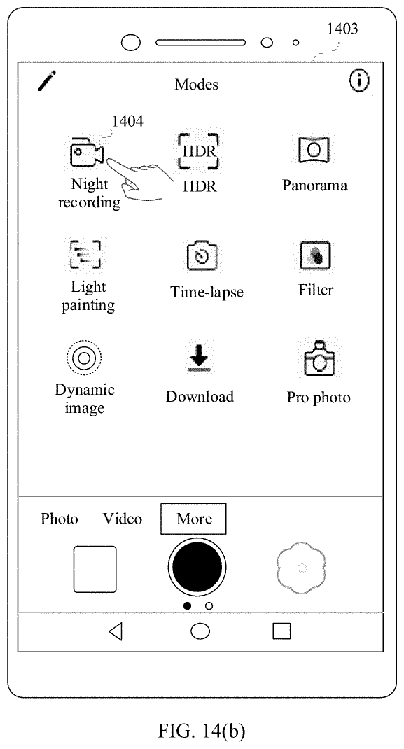

Optionally, in the photographing process, for example, the mobile phone displays a GUI shown in FIG. 14(a). The GUI is an interface 1401, and the interface 1401 is used to display a currently photographed video image, and includes a control 1402 used to indicate to display more other modes. When the mobile phone detects that the user selects the photographing control 1402, for example, the user taps the photographing control 1402, or the mobile phone detects that the user slides the photographing control 1402 to a center of the GUI, or the mobile phone detects that the user slides the photographing control 1402 to the above of a photographing key, the mobile phone displays a GUI shown in FIG. 14(b). The GUI is an interface 1403, and the interface 1403 displays a plurality of controls used to indicate a specific photographing mode, including a control 1404 used to indicate to detect the photographing environment brightness. When detecting that the user taps the photographing control 1404, the mobile phone enters the first photographing mode, that is, a night recording mode herein.

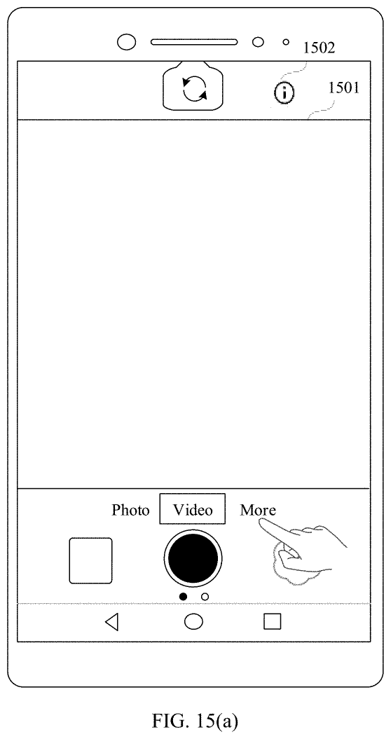

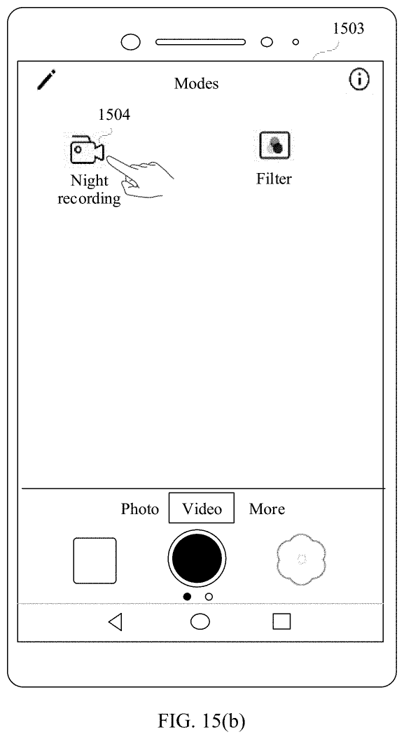

Optionally, in the photographing process, for example, the mobile phone displays a GUI shown in FIG. 15(a). The GUI is an interface 1501, and the interface 1501 is used to display a currently photographed video image, and includes a control 1502 used to indicate to display more other options. When the mobile phone detects that the user selects the photographing control 1502, for example, the user taps the photographing control 1502, or the mobile phone detects that the user slides the photographing control 1502 to a center of the GUI, or the mobile phone detects that the user slides the photographing control 1502 to the above of a photographing key, the mobile phone displays a GUI shown in FIG. 15(b). The GUI is an interface 1503, and the interface 1503 displays a plurality of controls used to indicate a specific photographing mode, including a control 1504 used to indicate to detect the photographing environment brightness. When detecting that the user taps the photographing control 1504, the mobile phone enters the first photographing mode, that is, a night recording mode herein.

It should be understood that the night mode, the night recording mode, or the artificial intelligence processing mode in this embodiment of this application is an optional name of the first photographing mode, and may be replaced with another name in a specific implementation process.

When it is detected that the first photographing mode is entered, the method 600 and the optional embodiments may be performed.

S1102: When the photographing environment brightness is less than a preset threshold, process, by using at least a first neural network, a first video image photographed in a case of the photographing environment brightness, to obtain a first target video image, where the first neural network is used to reduce noise of the first video image.

For an implementation of the first neural network and that of a first preset denoising algorithm, refer to related description in S602 in FIG. 6. Details are not described herein again.

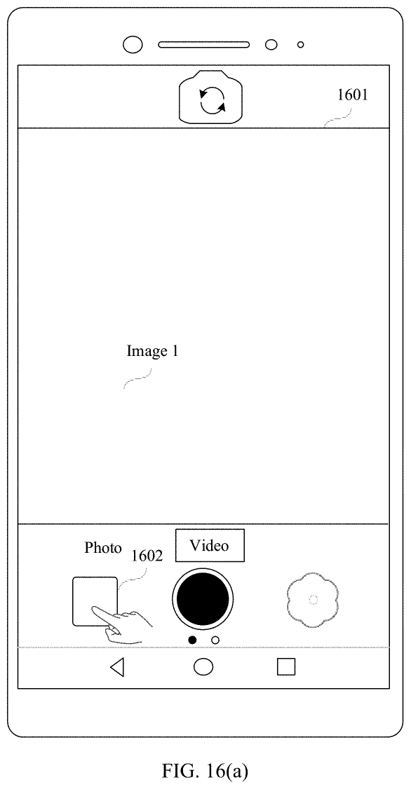

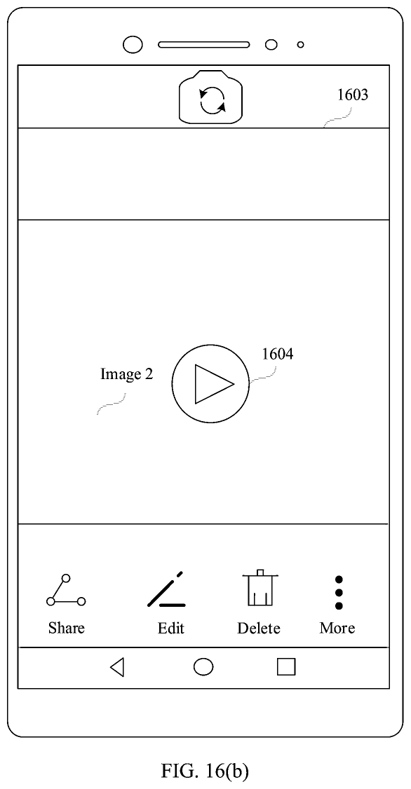

In the photographing process, for example, the mobile phone displays a GUI shown in FIG. 16(a). The GUI is an interface 1601, and the interface 1601 is used to display a currently photographed video image (for example, an image 1), and includes a control 1602 used to indicate to open a record stream. A preview stream includes the currently photographed video image. When detecting that the user selects the photographing control 1602, the mobile phone displays a GUI shown in FIG. 16(b). The GUI is an interface 1603, and the interface 1603 includes a stored video image (such as an image 2), and a control 1604 used to indicate to play the record stream. When detecting that the user selects the photographing control 1602, the mobile phone plays the record stream.

According to the method provided in this application, a video image is processed based on brightness of a photographed video. In a low illuminance or dark light condition, the photographed video is processed by using the first neural network and/or the second neural network. In a non-low illuminance or non-dark light condition, the photographed video is processed by using the first preset denoising algorithm that does not include a neural network. Therefore, it can be ensured that power consumption of the terminal is reduced as much as possible while a processing effect is improved. In addition, in a specific implementation process, the first neural network and the second neural network are accelerated by using an accelerator such as an NPU, to ensure real-time property of video image processing and play continuity, and reduce a waiting delay of a user. In addition, interaction methods in different user interfaces are used or the terminal detects a trigger condition, to trigger the terminal to enter the first photographing mode, which can improve diversity of solution implementation and improve user experience.

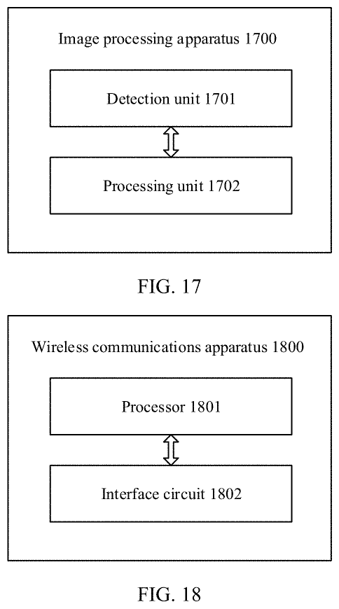

FIG. 17 is a schematic diagram of a structure of an image processing apparatus according to an embodiment of this application. The image processing apparatus may be a terminal, or may be a chip inside the terminal, and can implement the image processing method shown in FIG. 6 or FIG. 11 and the foregoing optional embodiments. As shown in FIG. 17, an image processing apparatus 1700 includes a detection unit 1701 and a processing unit 1702.

The detection unit 1701 is configured to perform any step of S601 in the method 600 and S1101 in the method 1100, and any optional embodiment thereof. The processing unit 1702 is configured to perform any step of S602 to S604 in the method 600 and S1101 and S1102 in the method 1100, and any optional example. For details, refer to detailed descriptions in the method examples. Details are not described herein again.

The detection unit 1701 is configured to detect photographing environment brightness during video photographing. The processing unit 1702 is configured to: when the photographing environment brightness is less than a preset threshold, process, by using at least a first neural network, a first video image photographed in a case of the photographing environment brightness, to obtain a first target video image, where the first neural network is used to reduce noise of the first video image.

It should be understood that the image processing apparatus in this embodiment of this application may be implemented by software, for example, implemented by a computer program or instructions that have the foregoing function. The corresponding computer program or instructions may be stored in a memory inside the terminal, and a processor reads the corresponding computer program or instructions in the memory to implement the foregoing function. Alternatively, the image processing apparatus in this embodiment of this application may be implemented by hardware. The processing unit 1702 is a processor (for example, a processor in an NPU, a GPU, or a system chip), and the detection unit 1701 is a detector. Alternatively, the image processing apparatus in this embodiment of this application may be implemented through combination of a processor and a software module.

Specifically, the detection unit may be an interface circuit of the processor, an ambient light sensor of the terminal, or the like. For example, the ambient light sensor of the terminal sends a detected photographing environment brightness measurement result to the interface circuit of the processor. The photographing environment brightness measurement result may be a quantized value or a result of comparison with the preset threshold. For example, a high level is used to indicate that the photographing environment brightness is less than the preset threshold, and a low level is used to indicate that the photographing environment brightness is greater than or equal to the preset threshold. The processor receives the photographing environment brightness measurement result. For another example, the processor may determine the photographing environment brightness by detecting a photographing parameter, or the processor may determine the photographing environment brightness by detecting average image brightness of a video image.

Optionally, that the processing unit 1702 is configured to: when the photographing environment brightness is less than a preset threshold, process, by using at least a first neural network, a first video image photographed in a case of the photographing environment brightness includes: The processing unit 1702 is configured to process, by using the first neural network and a second neural network, the first video image photographed in the case of the photographing environment brightness. The second neural network is used to optimize a dynamic range of the first video image.

Optionally, the processing unit 1702 is further configured to: when the photographing environment brightness is greater than or equal to the preset threshold, perform, by using a first preset denoising algorithm, denoising processing on a second video image photographed in the case of the photographing environment brightness, to obtain a second target video image.

The first preset denoising algorithm does not include a neural network.

Optionally, the processing unit 1702 is further configured to: before the detection unit detects the photographing environment brightness, enable the terminal to enter a first photographing mode, where the first photographing mode is used to indicate the terminal to detect the photographing environment brightness.

Optionally, that the processing unit 1702 is configured to: when the photographing environment brightness is less than a preset threshold, process, by using at least a first neural network, a first video image photographed in a case of the photographing environment brightness specifically includes: The processing unit 1702 is configured to: when determining that photographing environment brightness of an i^{th} frame of video image in the photographed video image is less than the preset threshold, process the i^{th} frame of video image by using at least the first neural network, where i is greater than 1.

Optionally, the image processing apparatus 1700 further includes a display unit 1703, configured to display a video image photographed in a case of current photographing environment brightness, or display the first target video image, or display the second target video image.

The display unit may be implemented by a display. The processor may enable the display to display the foregoing content. The display may be a display having a function. The display unit 1703 may be configured to perform any step of S605 to S607 in the method 600 and any optional example.

It should be understood that for processing details of the apparatus in this embodiment of this application, refer to related descriptions in FIG. 6 and FIG. 9. Details are not described again in this embodiment of this application.

FIG. 18 is a schematic diagram of a structure of another image processing apparatus according to an embodiment of this application. The image processing apparatus may be a terminal, or may be a chip inside the terminal, and can implement the image processing method shown in FIG. 6 or FIG. 18 and the foregoing optional embodiments. As shown in FIG. 18, an image processing apparatus 1800 includes a processor 1801 and an interface circuit 1802 coupled to the processor 1001. It should be understood that although FIG. 18 shows only one processor and one interface circuit, the image processing apparatus 1800 may include another quantity of processors and interface circuits.

The interface circuit 1802 is configured to connect to another component of the terminal, for example, a memory or another processor. The processor 1801 is configured to perform signal interaction with another component by using the interface circuit 1802. The interface circuit 1802 may be an input/output interface of the processor 1801.

For example, the processor 1801 reads, by using the interface circuit 1802, a computer program or instructions in a memory coupled to the processor 1801, and decodes and executes the computer program or the instructions. It should be understood that the computer program or the instructions may include a function program of the terminal, or may include a function program of the image processing apparatus applied to the terminal. When the corresponding function program is decoded and executed by the processor 1801, the terminal or the image processing apparatus in the terminal is enabled to implement the solutions in the image processing method provided in the embodiments of this application.

Optionally, the function program of the terminal is stored in a memory outside the image processing apparatus 1800. When the function program of the terminal is decoded and executed by the processor 1801, the memory temporarily stores a part or all of content of the function program of the terminal.

Optionally, the function program of the terminal is stored in a memory inside the image processing apparatus 1800. When the function program of the terminal is stored in the memory inside the image processing apparatus 1800, the image processing apparatus 1800 may be disposed in the terminal in the embodiments of the present invention.

Optionally, a part of content of the function program of the terminal is stored in a memory outside the image processing apparatus 1800, and the other part of the content of the function program of the terminal is stored in a memory inside the image processing apparatus 1800.

It should be understood that the image processing apparatus shown in any one of FIG. 1, FIG. 2, FIG. 17, and FIG. 18 may be combined with each other. For related design details of the image processing apparatus shown in any one of FIG. 1, FIG. 2, FIG. 17, and FIG. 18, and those of the optional embodiments, refer to related design details of the image processing method shown in any one of FIG. 6 or FIG. 11, and those of the optional embodiments. Details are not described herein again.

It should be understood that the image processing method shown in any one of FIG. 6 or FIG. 11 and the optional embodiments, and the image processing apparatus shown in any one of FIG. 1, FIG. 2, FIG. 17, and FIG. 18 and the optional embodiments not only may be configured to process a video or an image that is being photographed, but also may be configured to process a photographed video or image. This is not limited in this application.

Terms “first”, “second”, “third”, “fourth”, and the like in this application and the accompanying drawings are used to distinguish between similar objects, and do not need to be used to describe a specific order or sequence. In addition, the terms “include”, “have”, and any other variants thereof are intended to indicate non-exclusive inclusions, for example, including a series of steps or units. The method, system, product, or device is not limited to the steps or units that are literally listed, but may include other steps or units that are not literally listed or that are inherent to these processes, methods, products, or devices.

It should be understood that in this application, “at least one” means one or more, and “a plurality of” means two or more. The term “and/or” is used to describe an association relationship between associated objects, and indicates that three relationships may exist. For example, “A and/or B” may indicate the following three cases: Only A exists, only B exists, and both A and B exist, where A and B may be singular or plural. The character “I” generally indicates an “or” relationship between the associated objects. “At least item (piece) of the following” or a similar expression thereof means any combination of these items, including a single item (piece) or any combination of plural items (pieces). For example, at least one (piece) of a, b, or c may represent: a, b, c, “a and b”, “a and c”, “b and c”, or “a, b, and c”, where a, b, and c may be singular or plural.

It should be understood that sequence numbers of the foregoing processes do not mean execution sequences in this application. The execution sequences of the processes should be determined based on functions and internal logic of the processes, and should not be construed as any limitation on implementation processes of embodiments of this application. The term “coupling” mentioned in this application is used to indicate interworking or interaction between different components, and may include a direct connection or an indirect connection through another component.

All or a part of the foregoing embodiments of this application may be implemented by using software, hardware, firmware, or any combination thereof. When software is used to implement embodiments, all or a part of embodiments may be implemented in a form of a computer program product. The computer program product includes one or more computer instructions. When the computer program instructions are loaded and executed on a computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable or an optical fiber) or wireless (for example, infrared, radio, or microwave) manner. The computer-readable storage medium may be any usable medium accessible by the computer, or a data storage device, such as a server or a data center, integrating one or more usable media. The usable medium may be a magnetic medium, for example, a floppy disk, a hard disk, or a magnetic tape, may be an optical medium, for example, a DVD, or may be a semiconductor medium, for example, a solid-state drive (Solid-State Drive, SSD).

In the embodiments of this application, the memory refers to a component or circuit that has a data or information storage capability, and may provide instructions and data for a processor. The memory includes a read-only memory (ROM, Read-Only Memory), a random access memory (RAM, Random Access Memory), a nonvolatile random access memory (NVRAM), a programmable read-only memory, an electrically erasable programmable memory, a register, or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An image processing method, wherein the method comprises:
detecting photographing environment brightness during video photographing; and
when the photographing environment brightness is less than a preset threshold, processing, by using at least a first neural network, a first video image photographed in a case of the photographing environment brightness, to obtain a first target video image, wherein
the first neural network is used to reduce noise of the first video image.

2. The method according to claim 1, wherein the method further comprises:
when the photographing environment brightness is greater than or equal to the preset threshold, performing, by using a first preset denoising algorithm, denoising processing on a second video image photographed in the case of the photographing environment brightness, to obtain a second target video image, wherein
the first preset denoising algorithm does not comprise a neural network.

3. The method according to claim 2, wherein a photographing frame rate corresponding to the first video image is less than a photographing frame rate corresponding to the second video image.

4. The method according to claim 3, wherein a value range of the photographing frame rate corresponding to the first video image comprises [24, 30] fps.

5. The method according to claim 1, wherein before the detecting photographing environment brightness, the method further comprises:
entering a first photographing mode, wherein the first photographing mode is used to indicate a terminal to detect the photographing environment brightness.

6. The method according to claim 1, wherein the processing, by using at least a first neural network, a video image photographed in a case of the photographing environment brightness specifically comprises:
processing, by using the first neural network and a second neural network, the video image photographed in the case of the photographing environment brightness, wherein
the second neural network is used to optimize a dynamic range of the first video image.

7. The method according to claim 1, wherein when the photographing environment brightness is less than the preset threshold, the processing, by using at least a first neural network, a first video image photographed in a case of the photographing environment brightness specifically comprises:
when determining that photographing environment brightness of an i^{th} frame of video image in the photographed video image is less than the preset threshold, processing the i^{th} frame of video image by using the first neural network, wherein i is greater than 1.

8. The method according to claim 7, wherein the detecting photographing environment brightness of a video image specifically comprises:
determining the photographing environment brightness of the video image based on a photographing parameter for photographing a video, sensing information of an ambient light sensor of the terminal photographing the video, or average image brightness of the video image, wherein
the photographing parameter comprises one or more of photosensibility, exposure time, or an aperture size.

9. The method according to claim 7, wherein the preset threshold is less than or equal to 5 lux.

10. The method according to claim 7, wherein the method further comprises:
displaying a video image photographed in a case of current photographing environment brightness;
displaying the first target video image; or
displaying the second target video image.

11. An image processing apparatus, wherein the apparatus comprises:
a detection unit, configured to detect photographing environment brightness during video photographing; and
a processing unit, configured to: when the photographing environment brightness is less than a preset threshold, process, by using at least a first neural network, a first video image photographed in a case of the photographing environment brightness, to obtain a first target video image, wherein
the first neural network is used to reduce noise of the first video image.

12. The apparatus according to claim 11, wherein
the processing unit is further configured to: when the photographing environment brightness is greater than or equal to the preset threshold, perform, by using a first preset denoising algorithm, denoising processing on a second video image photographed in the case of the photographing environment brightness, to obtain a second target video image, wherein
the first preset denoising algorithm does not comprise a neural network.

13. The apparatus according to claim 12, wherein a photographing frame rate corresponding to the first video image is less than a photographing frame rate corresponding to the second video image.

14. The apparatus according to claim 13, wherein a value range of the photographing frame rate corresponding to the first video image comprises [24, 30] fps.

15. The apparatus according to claim 11, wherein
the processing unit is further configured to: before the detection unit detects the photographing environment brightness, enable a terminal to enter a first photographing mode, wherein the first photographing mode is used to indicate the terminal to detect the photographing environment brightness.

16. The apparatus according to claim 11, wherein that the processing unit is configured to: when the photographing environment brightness is less than a preset threshold, process, by using at least a first neural network, a first video image photographed in a case of the photographing environment brightness specifically comprises:
the processing unit is configured to: when the photographing environment brightness is less than the preset threshold, process, by using the first neural network and a second neural network, the video image photographed in the case of the photographing environment brightness, wherein
the second neural network is used to optimize a dynamic range of the first video image.

17. The apparatus according to claim 11, wherein that the processing unit is configured to: when the photographing environment brightness is less than a preset threshold, process, by using at least a first neural network, a first video image photographed in a case of the photographing environment brightness specifically comprises:
the processing unit is configured to: when determining that photographing environment brightness of an i^{th} frame of video image in the photographed video image is less than the preset threshold, process the i^{th} frame of video image by using the first neural network, wherein i is greater than 1.

18. The apparatus according to claim 17, wherein that the detection unit is configured to detect photographing environment brightness during video photographing specifically comprises:
the detection unit is configured to determine the photographing environment brightness of the video image based on a photographing parameter for photographing a video, sensing information of an ambient light sensor of the terminal photographing the video, or average image brightness of the video image, wherein
the photographing parameter comprises one or more of photosensibility, exposure time, or an aperture size.

19. The apparatus according to claim 17, wherein the preset threshold is less than or equal to 5 lux.

20. The apparatus according to claim 17, wherein the apparatus further comprises:
a display unit, wherein
the display unit is configured to display a video image photographed in a case of current photographing environment brightness;
the display unit is configured to display the first target video image; or
the display unit is configured to display the second target video image.
